(19) United States
(12) Patent Application Publication
(10) Pub. No.: US 2025/0130562 A1
(43) Pub. Date: Apr. 24, 2025

(54) CONSTRAINT CONDITION ACQUISITION DEVICE, CONTROL SYSTEM, CONSTRAINT CONDITION ACQUISITION METHOD, AND RECORDING MEDIUM

(71) Applicant: NEC Corporation, Minato-ku, Tokyo (JP)

(72) Inventors: Hiroyuki OYAMA, Tokyo (JP); Rin TAKANO, Tokyo (JP)

(73) Assignee: NEC Corporation, Minato-ku, Tokyo (JP)

(21) Appl. No.: 18/688,892

(22) PCT Filed: Sep. 22, 2021
(86) PCT No.: PCT/JP2021/034886

§ 371 Date: Mar. 4, 2024

(51) Int. Cl. G05B 23/02

(52) U.S. Cl. CPC G05B 23/0221

(57) ABSTRACT

A constraint condition acquisition device acquires success time time-series data, which is time-series data pertaining to control over a control target when a predetermined task carried out through the control is successful, and failure time time-series data, which is the time-series data in the case of task failure; acquires a constraint condition template, which is a constraint condition that includes a parameter; and determines the value of the parameter such that the constraint condition holds in the success time-series data and the constraint condition does not hold in the failure time-series data.

### TECHNICAL FIELD

The present invention relates to a constraint condition acquisition device, a control system, a constraint condition acquisition method, and a recording medium.

### BACKGROUND ART

Constraint conditions may be set in the control of a robot or other control target, and control may be performed to satisfy the constraint conditions.

For example, in the robot control device described in Patent Document 1, the movable range of the robot arm to be controlled is divided into four spaces in advance. Then, for each divided range of motion, the applied acceleration (derivative of acceleration) constraint value for each joint is set in advance so that the load torque generated in the transmission elements such as reducers is within the allowable range. The robot controller solves the optimization problem using the acceleration constraint values as inequality constraints to obtain control command values that cause the robot arm to follow a specified trajectory.

### PRIOR ART DOCUMENTS

### Patent Document

Patent Document 1: Japanese Unexamined Patent Application Publication No. 2014-014876

### SUMMARY OF THE INVENTION

### Problems to be Solved by the Invention

If constraint conditions other than the preset ones can be obtained when controlling the control target, it will reduce the burden on the operator to set the constraint conditions, and it will also allow control to be performed when there are constraints that have not been clarified.

An example of an object of the present invention is to provide a constraint condition acquisition device, a control system, a constraint condition acquisition method, and a recording medium that can solve the above-mentioned problems.

### Means for Solving the Problem

According to the first example aspect of the invention, the constraint condition acquisition device is provided with: a time-series data acquisition means that acquires success time time-series data, which is time-series data pertaining to control over a control target when a predetermined task carried out through the control is successful, and failure time time-series data, which is the time-series data in the case of task failure; a template acquisition means that acquires a constraint condition template, which indicates a constraint condition that includes a parameter; and a constraint condition calculation means that determines the value of the parameter such that the constraint condition holds in the success time-series data and does not hold in the failure time-series data.

According to the second example aspect of the invention, the control system is provided with an operation instruction means that, when a predetermined task is executed through control over a control target, instructs a user operation on the control target in order to execute the task under a more relaxed constraint condition than the constraint condition set for the control.

According to the third example aspect of the invention, the control system is provided with: a time-series data acquisition means that acquires success time-series data, which is time-series data pertaining to control over a control target when a predetermined task carried out through the control is successful, and failure time time-series data, which is the time-series data in the case of task failure; a template acquisition means that acquires a constraint condition template, which is a constraint condition that includes a parameter; a constraint condition calculation means that determines the value of the parameter such that the constraint condition holds in the success time-series data and the constraint condition does not hold in the failure time-series data; and a control means that executes the predetermined task by controlling the control target in accordance with the constraint condition in which the value of the parameter determined in the constraint condition template is set and indicated.

According to the fourth example aspect of the invention, the constraint condition acquisition method includes a computer acquiring success time-series data, which is time-series data pertaining to control over a control target when a predetermined task carried out through the control is successful, and failure time-series data, which is the time-series data in the case of task failure; acquiring a constraint condition template, which is a constraint condition that includes a parameter; and determining the value of the parameter such that the constraint condition holds in the success time-series data and the constraint condition does not hold in the failure time-series data.

According to the fifth example aspect of the invention, the recording medium is a recording medium that records a program for causing a computer to execute the steps of: acquiring success time time-series data, which is time-series data pertaining to control over a control target when a predetermined task carried out through the control is successful, and failure time time-series data, which is the time-series data in the case of task failure; acquiring a constraint condition template, which is a constraint condition that includes a parameter; and determining the value of the parameter such that the constraint condition holds in the success time-series data and the constraint condition does not hold in the failure time-series data.

### Effect of Invention

According to the present invention, a constraint condition other than a constraint condition set in advance can be acquired.

### BRIEF DESCRIPTION OF THE DRAWINGS

FIG. 1 is a diagram showing an example of the configuration of the control system according to the first example embodiment.

FIG. 2 is a diagram showing an example of the configuration of the constraint condition acquisition device according to the first example embodiment.

FIG. 3 is a diagram showing an example of data input/output in the control system according to the first example embodiment.

FIG. 4 is a diagram showing an example of the operation of an object being controlled according to the first example embodiment.

FIG. 5 is a diagram showing an example of the relationship between time-series data and areas set as unknown inequality constraint conditions according to the first example embodiment.

FIG. 6 is a diagram showing an example of the selection criteria for the framework of the solution search problem according to the first example embodiment.

FIG. 7 is a diagram showing an example of data to be integrated by the integration portion according to the first example embodiment.

FIG. 8 is a diagram showing an example of the processing steps performed by the control system according to the first example embodiment.

FIG. 9 is a diagram showing an example of the configuration of a constraint condition acquisition device according to a modification of the first example embodiment.

FIG. 10 is a diagram showing an example of updating a constraint condition according to a modification of the first example embodiment.

FIG. 11 is a diagram showing example of data input/output in a control system according to a modification of the first example embodiment.

FIG. 12 is a diagram showing an example of the processing procedure in the control system according to a modification of the first example embodiment.

FIG. 13 is a diagram showing an example of data input/output when the constraint condition acquisition device according to a modification of the first example embodiment uses a temporal logic expression in addition to the constraint condition.

FIG. 14 is a diagram showing an example of an area indicated by a constraint condition expressed using a temporal logic expression according to a modification of the first example embodiment.

FIG. 15 is a diagram showing an example of the configuration of the control system according to the second example embodiment.

FIG. 16 is a diagram showing an example of data input/output in the control system according to the second example embodiment.

FIG. 17 is a diagram showing an example of the screen display by the operation instruction portion according to the second example embodiment.

FIG. 18 is a diagram showing an example of the configuration of the constraint condition acquisition device according to the third example embodiment.

FIG. 19 is a diagram showing an example of the configuration of the control system according to the fourth example embodiment.

FIG. 20 is a diagram showing an example of the configuration of the control system according to the fifth example embodiment.

FIG. 21 is a diagram showing an example of the processing steps in the constraint condition acquisition method according to the sixth example embodiment.

FIG. 22 is an outline block diagram showing the configuration of a computer according to at least one example embodiment.

### EXAMPLE EMBODIMENT

The following is a description of example embodiments of the present invention, but the following example embodiments do not limit the scope of the claims. Not all of the combinations of features described in the example embodiments are essential to the solution of the invention.

### First Example Embodiment

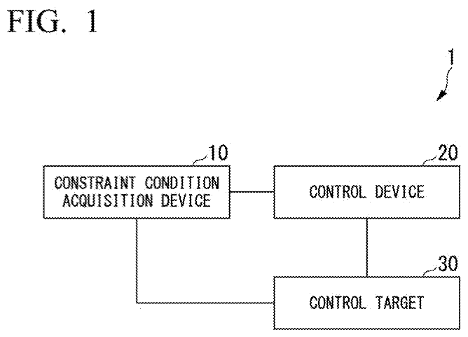

FIG. 1 is a diagram showing an example of the configuration of the control system according to the first example embodiment. In the configuration shown in FIG. 1, a control system 1 is provided with a constraint condition acquisition device 10, a control device 20, and a control target 30.

The control system 1 controls the control target 30. In the control system 1, a task to be executed by controlling the control target 30 is set. The control system 1 controls the control target 30 so as to execute the set task.

In the following, accomplishing a task is also referred to as task success or simply success. Failure to accomplish a task is also referred to as task failure or simply failure.

In the following, the case where the control target 30 is a robot arm (vertically articulated robot) will be used as an example. However, the target of control by the control system 1 is not limited to specific ones. The control target 30 may be configured as a single device or as a system combining multiple devices, such as a plant or production line. Alternatively, the control target 30 may be part of a device.

The control target 30 may be configured as part of the control system 1. Alternatively, the control target 30 may be a configuration external to the control system 1.

The constraint condition acquisition device 10 sets a constraint condition in the control of the control target 30. Specifically, the constraint condition acquisition device 10 acquires time-series data of the control of the control target 30 for each case of task success and task failure. The time-series data pertaining to control of the control target 30 is also referred to simply as time-series data. The time-series data in the case of task success is also referred to as success time-series data. The time-series data in the case of task failure is also referred to as failure time-series data.

The constraint condition acquisition device 10 sets the constraint condition so that the constraint condition is satisfied in the success time-series data and the constraint condition is not satisfied in the failure time-series data. Here, a constraint condition being satisfied may mean that all of multiple constraint conditions are satisfied at all times in the time-series data. Failure of a constraint condition may be the failure of one or more of the multiple constraint conditions at least some time in the time-series data.

The constraint condition acquisition device 10 is composed of a computer, such as a personal computer (PC). Alternatively, the constraint condition acquisition device 10 may be configured using hardware dedicated to the constraint condition acquisition device 10, such as configured using an Application Specific Integrated Circuit (ASIC) or Field Programmable Gate Array (FPGA).

The control device 20 controls the control target 30 so as to satisfy the constraint condition set by the constraint condition acquisition device 10. Satisfying a constraint condition here means that the constraint condition is satisfied or that the constraint condition is made to be satisfied.

As a means for the control device 20 to control the control target 30, for example, the control device 20 may determine the trajectory of the control target 30 by solving an optimization problem that includes the constraint condition set by the constraint condition acquisition device 10. The control device 20 may then control the control target 30 so as to operate the control target 30 along the determined trajectory.

The control device 20 corresponds to an example of a control means.

The control device 20 is composed of a computer, such as a personal computer. Alternatively, the control device 20 may be configured using hardware dedicated to the control device 20, such as configured using an ASIC or FPGA.

The constraint condition acquisition device 10 and the control device 20 may be integrally configured. For example, the constraint condition acquisition device 10 and the control device 20 may run on the same computer.

Here, time is expressed in time steps, denoted as time 0, 1, . . . .

The dynamics model of the control target 30 in one step of the time step can be expressed as in Expression (1).

$$\begin{matrix}[ Expression 1 ] & \\ {x}_{t + 1} = f ( {x}_{t} , {u}_{t} ) & ( 1 )\end{matrix}$$

t is an integer representing time in time steps.

uₜ is a vector representing the control command value for the control target 30 at time t. The control command value to the control target 30 is also referred to as the input to the control target 30, or simply input. uₜ is also referred to as input uₜ.

xₜ is a vector representing the state that can be observed or estimated at time t, such as the position of the control target 30 at time t. As described above, the case shall be described where the control target 30 is a robot arm, with the position information of the distal end portion of the control target 30 assumed to be included in xₜ. The position of the distal end portion of the control target 30 may be the position of the end effector of the control target 30. xₜ is also referred to as the state xₜ.

However, the state information acquired by the control system 1 is not limited to any particular one.

The function f represents the behavior of the control target 30 with respect to the input uₜ in state xₜ at time t. The change from state xₜ to state xₜ₊₁ happens by the operation of the control target 30.

The time-series data ξⱼ of the control of the control target 30 in one task execution is shown in Expression (2).

$$\begin{matrix}[ Expression 2 ] & \\ {ξ}_{j} = {[ {x}_{0}^{T} , … , {x}_{{N}_{t}}^{T} , {u}_{0}^{T} , … , {u}_{{N}_{t} - 1}^{T} ]}^{T} , j = 1 , … , {N}_{s} & ( 2 )\end{matrix}$$

Nₛ represents the number of time-series data acquired by the constraint condition acquisition device 10. The number of time-series data acquired by the constraint condition acquisition device 10 can also be said to be the number of samples acquired by the constraint condition acquisition device 10.

j represents an identification number that identifies the time-series data.

Nₜ indicates the last time in the time-series data. The time Nₜ may be different for each time-series data. In this case, the number of elements of ξⱼ as a vector may be different for each time-series data. Alternatively, dummy data may be provided for time-series data with a small number of time steps to align the number of elements of ξⱼ as a vector.

A superscript “T” on a vector or matrix indicates the transposition of that vector or matrix. In the example in Expression (2), the time-series data ξⱼ is represented by a column vector with all elements arranged in a single column by transposing the vectors.

Each of the time-series data ξⱼ is tied to information indicating whether the task succeeded or failed. The time-series data ξⱼ in the case of task success is also denoted as ξⱼ^{s}. ξⱼ^{s} is also referred to as success time-series data ξⱼ^{s}. The time-series data ξⱼ in the case of task failure is also denoted as ξⱼ^{f}. ξⱼ^{f} is also referred to as failure time-series data ξⱼ^{f}.

The state xₜ included in the time-series data ξⱼ is also denoted as state x_{j, t}. The input uₜ in the time-series data ξⱼ is also denoted as input u_{j, t}.

The Nₛ time-series data acquired by the constraint condition acquisition device 10 can be expressed as ξ in Expression (3).

$$\begin{matrix}[ Expression 3 ] & \\ ξ = {[ {ξ}_{1}^{T} , … , {ξ}_{{N}_{S}}^{T} ]}^{T} & ( 3 )\end{matrix}$$

In Expression (3), ξ is represented as a column vector with all elements arranged in one column by transposition of vectors.

ξ is also referred to as training data. Training here means that the constraint condition acquisition device 10 acquires a new constraint condition in the control of the control target 30.

The constraint condition acquisition device 10 may acquire training data obtained using actual equipment of the control target 30. Alternatively, the constraint condition acquisition device 10 may acquire training data from simulations of the operation of the control target 30.

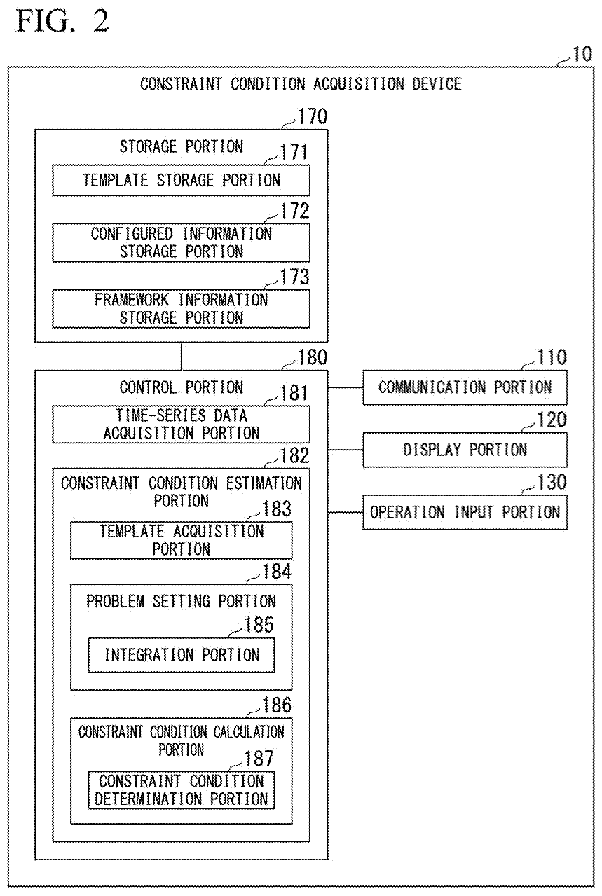

FIG. 2 is a diagram showing an example of the configuration of the constraint condition acquisition device 10. In the configuration shown in FIG. 2, the constraint condition acquisition device 10 is provided with a communication portion 110, a display portion 120, an operation input portion 130, a storage portion 170, and a control portion 180. The storage portion 170 is provided with a template storage portion 171, a configured information storage portion 172, and a framework information storage portion 173. The control portion 180 is provided with a time-series data acquisition portion 181 and a constraint condition estimation portion 182. The constraint condition estimation portion 182 is provided with a template acquisition portion 183, a problem setting portion 184, and a constraint condition calculation portion 186. The problem setting portion 184 is provided with an integration portion 185. The constraint condition calculation portion 186 is provided with a constraint condition determination portion 187.

The communication portion 110 communicates with other devices. For example, the communication portion 110 may communicate with the control device 20 and the control target 30, or either one of them, to acquire the training data. Alternatively, the communication portion 110 may communicate with a simulator that simulates the operation of the control target 30 to acquire the training data.

The communication portion 110 transmits information indicating the constraint condition set by the constraint condition acquisition device 10 to the control device 20.

The display portion 120 is provided with a display screen, such as a liquid crystal panel or LED (Light Emitting Diode) panel, for example, and displays various images. For example, the display portion 120 may display information indicating the constraint condition set by the constraint condition acquisition device 10. The display portion 120 may display information indicating the constraint condition set by the constraint condition acquisition device 10 in expressions such as inequalities and equations.

The operation input portion 130 is provided with input devices such as a keyboard and mouse, for example, and receives user operations. For example, the operation input portion 130 may receive user operations that instruct the setting of constraint conditions and the control of the control target 30. If the user inputs a known constraint condition in the control of the control target 30, the operation input portion 130 may receive the user operation to input the constraint condition.

The storage portion 170 stores various data. The storage portion 170 is configured using the storage device provided by the constraint condition acquisition device 10.

The template storage portion 171 stores multiple constraint condition templates. The constraint condition template is information that represents constraints on the operation of the control target 30. The constraint condition template is represented, for example, by an inequality including parameters. By setting values for the parameters of the constraint condition template, inequality constraint conditions in the control of the control target 30 are obtained. An inequality constraint condition is a constraint condition expressed by an inequality.

For example, a constraint condition template may be provided for the control of the movement of the control target 30 in a two-dimensional coordinate space, indicating an elliptical area as an area into which the control target 30 cannot enter due to obstacles or other factors. In this case, the coordinates of the center point of the ellipse, the diameter of the ellipse in the first coordinate axis direction, and the diameter of the ellipse in the second coordinate axis direction may be parameters. The constraint condition template does not have to be a constraint condition representing an elliptical area, and may be a rectangular area, or even a polygonal area. Constraint condition templates are not limited to the examples described above. The constraint condition template may be constructed using a neural network or Gaussian process model, or the like.

The constraint condition template may be set manually, for example, by the user of the control system 1.

A constraint condition generated by the constraint condition acquisition device 10 using the constraint condition template is also referred to as an unknown constraint condition. “Unknown” here means that the constraint condition is not set in advance, but is the constraint condition to be generated by the constraint condition acquisition device 10.

An unknown constraint condition may be a constraint condition expressed as an inequality. The unknown constraint condition in this case is also referred to as unknown inequality constraint condition.

The configured information storage portion 172 stores configured information. Configured information here is predetermined information. Configured information may include a known constraint condition, cost function, and control parameter information.

Known constraint conditions here refer to constraint conditions in the control of the control target 30 other than unknown constraint conditions. “Known” here means that the constraint condition is preset.

The cost function here is a function that indicates evaluation of the control of the control target 30 in terms of cost.

The control parameter information here is information indicating the values of parameters in various predetermined formulas, such as known constraint conditions and cost functions. The control parameter information may be used by the control device 20 to generate control inputs to the control target 30.

The configured information or a part thereof may be set manually, for example, by the user of the control system 1.

The framework information storage portion 173 stores a plurality of framework information. The framework information here is information that indicates the framework of the solution search problem that the constraint condition acquisition device 10 solves to calculate the parameter values of the constraint condition template. The solution search problem here is the problem of finding a solution that satisfies the set constraint condition. The solution search problem involves an optimization problem.

In the optimization problem, an objective function is set in addition to the constraint condition, and a solution that optimizes the objective function value is searched among the solutions that satisfy the constraint condition. Optimization of the objective function value may be to make the objective function value as small as possible. Alternatively, optimization of the objective function value may be to make the objective function value as large as possible. In an optimization problem, a termination condition for the solution search is set, the solution is searched until the termination condition is satisfied, and so on.

On the other hand, a solution search problem may be a problem in which no objective function is presented and a solution is sought that satisfies a set constraint condition.

For example, the framework information may be information indicating how to assign multiple constraint conditions in the control of the control target 30 to the objective function in the solution search problem or to the constraint condition, depending on the type of constraint condition.

Depending on which of the multiple framework information is used by the constraint condition acquisition device 10, the computational complexity, ease of obtaining a solution, and accuracy of the solution to the solution search problem will vary. The framework information may be selected by the constraint condition acquisition device 10 according to the number of constraint conditions and other index values of computational complexity.

The constraint condition acquisition device 10 may select framework information that leads to a solution search problem whose solution is relatively difficult to obtain, and when a solution is obtained, the accuracy of the solution is relatively high, and then proceed with the setting of the solution search problem and solution search. If a solution cannot be obtained with the selected framework information, the constraint condition acquisition device 10 may select framework information that leads to a solution search problem whose solution is relatively easy, and when a solution is obtained, the accuracy of the solution is relatively low, and then redo the setting of the solution search problem and solution search.

The control portion 180 controls the various parts of the constraint condition acquisition device 10 to perform various processes. The functions of the control portion 180 may be performed, for example, by the Central Processing Unit (CPU) provided by the constraint condition acquisition device 10, which reads and executes a program from the storage portion 170.

The time-series data acquisition portion 181 acquires training data. For example, the time-series data acquisition portion 181 may extract training data from the reception data of the communication portion 110. The time-series data acquisition portion 181 acquires training data including success time-series data ξⱼ^{s} and failure time-series data ξⱼ^{f}.

The time-series data acquisition portion 181 corresponds to an example of a time-series data acquisition means.

The constraint condition estimation portion 182 estimates unknown constraint conditions based on the training data.

The template acquisition portion 183 acquires a constraint condition template. Specifically, the template acquisition portion 183 excludes constraint condition templates that do not conform to the training data among the multiple constraint condition templates stored by the template storage portion 171 from the acquisition target. The template acquisition portion 183 then selects any of the remaining constraint condition templates for acquisition.

In determining conformance with the training data, the template acquisition portion 183 judges as non-conforming and excludes from acquisition those constraint condition templates for which no parameter values exist that would cause the constraint condition to be satisfied in the success time-series data and not satisfied in the failure time-series data.

If multiple constraint condition templates remain for acquisition, the method by which the template acquisition portion 183 selects one of the constraint condition templates is not limited to a specific method. For example, the template acquisition portion 183 may randomly select any one of multiple constraint condition templates. Alternatively, a priority order of selection may be preset for the constraint condition templates, with the template acquisition portion 183 selecting the constraint condition templates according to the priority order.

The method of determining priority in this case is not limited to a specific method. For example, a constraint condition template that represents a larger area may have a higher priority. Then, the template acquisition portion 183 may first select the constraint condition template that represents the large area according to the priority order. If the selected template does not fit the training data, the template acquisition portion 183 may re-select a constraint condition template representing a smaller area according to the priority order.

Alternatively, priorities for constraint condition templates may be pre-set based on the importance of the constraint condition. For example, in a pick and place task, the priority of a constraint condition template representing a safety-related constraint, such as the robot not hitting a box, may be set higher than the priority of a constraint condition template representing a constraint for task success, such as not dropping an item.

The template acquisition portion 183 may acquire multiple constraint condition templates. In such cases, the template acquisition portion 183 may acquire multiple constraint condition templates at one time. Alternatively, the template acquisition portion 183 may acquire one constraint condition template at a time and repeat the acquisition of constraint condition templates.

The template acquisition portion 183 corresponds to an example of a template acquisition means.

The problem setting portion 184 sets a solution search problem for the constraint condition acquisition device 10 to calculate the parameter value of the constraint condition template. In particular, the problem setting portion 184 selects any of the framework information stored by the framework information storage portion 173. In this way, the problem setting portion 184 determines the assignment method of assigning multiple constraint conditions in the control of the control target 30 to an objective function in the solution search problem or to the constraint condition in the solution search problem, depending on the type of constraint conditions. The problem setting portion 184 sets the solution search problem according to the determined assignment method.

If the parameter values are not determined in the set solution search problem, the problem setting portion 184 may re-set the solution search problem. In this case, the problem setting portion 184 re-selects any of the framework information stored by the framework information storage portion 173. The problem setting portion 184 then sets a solution search problem based on the assignment method indicated by the newly selected framework information.

The problem setting portion 184 corresponds to an example of a problem setting means.

The integration portion 185 integrates multiple inequality constraints in a solution search problem into a single inequality constraint condition. Integration of constraint conditions here refers to replacing multiple constraint conditions with a single constraint condition.

The integration portion 185 integrates a plurality of inequality constraint conditions in the solution search problem, obtained by inputting each of the multiple time-series data into the same constraint condition in the control of the control target 30, into a single inequality constraint condition. Specifically, the integration portion 185 finds the maximum or minimum value of the function that constitutes the inequality constraint for each of the time-series data and time. The integration portion 185 integrates multiple inequality constraint conditions in the solution search problem into an inequality constraint condition using the maximum or minimum value obtained.

In this case, the process by which the integration portion 185 integrates the inequality constraint conditions in the solution search problem corresponds to the process of approximately finding the constraint condition closest to the inequality boundary (the constraint condition with the strictest constraint condition) among the multiple inequality constraint conditions.

The integration portion 185 integrates multiple inequality constraint conditions in the solution search problem, which are obtained according to the multiple inequality constraint conditions in the control of the control target 30, into a single inequality constraint condition. Specifically, the integration portion 185 integrates the multiple functions that constitute the multiple inequality constraint conditions in the control of the control target 30 into a function that approximates the maximum value for each argument value of those multiple function values, or a function that approximates the minimum value for each argument value of those multiple function values. In this case as well, the process by which the integration portion 185 integrates the inequality constraint conditions in the solution search problem corresponds to the process of approximately finding the constraint condition closest to the inequality boundary (the constraint condition with the strictest constraint condition) among the multiple inequality constraint conditions.

Integration of constraint conditions by the integration portion 185 corresponds to taking the logical OR of areas where the inequality constraint conditions do not hold (i.e., obtaining the union set of these areas). The fact that one or more of the individual constraint conditions before integration do not hold indicates that the constraint conditions after integration will not hold.

The integration portion 185 uses differentiable functions as functions to approximate the maximum and minimum values, respectively. This makes it relatively easy to solve the solution search problem with the integrated constraint conditions.

The constraint condition calculation portion 186 calculates the parameter values of the constraint condition template by solving the solution search problem set by the problem setting portion 184. The constraint condition calculation portion 186 determines the values of the parameters so that the constraint condition is satisfied in the success time-series data and the constraint condition is not satisfied in the failure time-series data.

The constraint condition calculation portion 186 corresponds to an example of a constraint condition calculation means.

The constraint condition determination portion 187 determines whether the parameter values of the constraint condition template have been obtained. For example, the constraint condition determination portion 187 determines whether the condition set as the termination condition for the solution search problem is satisfied. Alternatively, the constraint condition determination portion 187 may directly determine whether parameter values satisfying the constraint conditions set in the solution search problem have been obtained.

If it is determined that the parameter values of the constraint condition template have not been obtained, the constraint condition determination portion 187 determines whether selectable framework information remains among the framework information stored by the framework information storage portion 173. If the constraint condition determination portion 187 determines that selectable framework information remains, the constraint condition estimation portion 182 starts the process of estimating the unknown constraint conditions over again from the selection of framework information by the problem setting portion 184. On the other hand, if the constraint condition determination portion 187 determines that no selectable framework information remains, the constraint condition estimation portion 182 starts the process of estimating the unknown constraint conditions over again from the selection of the constraint condition template by the template acquisition portion 183. Furthermore, if the constraint condition determination portion 187 determines that no selectable constraint condition templates remain among the constraint condition templates stored by the template storage portion 171, the constraint condition estimation portion 182 determines that the estimation of unknown constraint conditions failed and terminates the process.

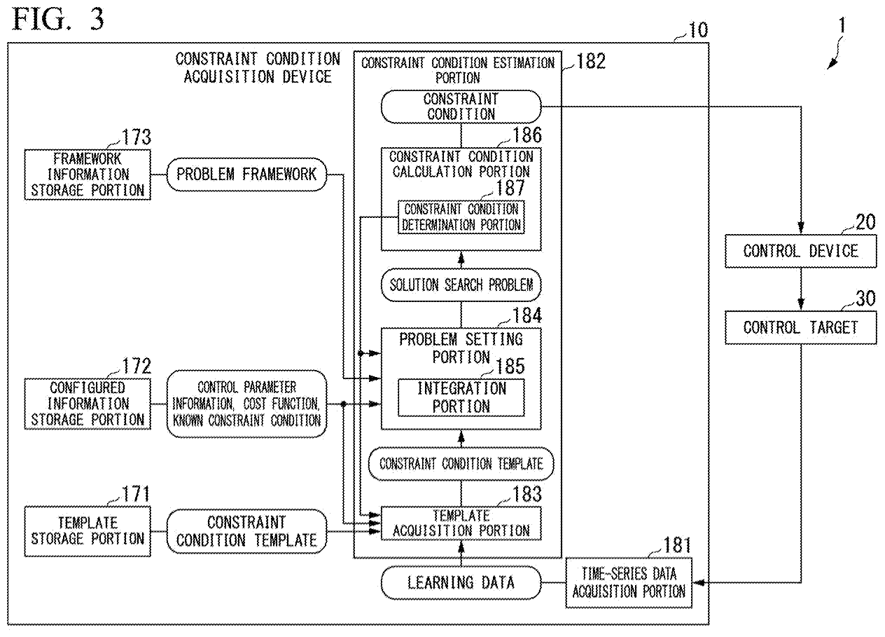

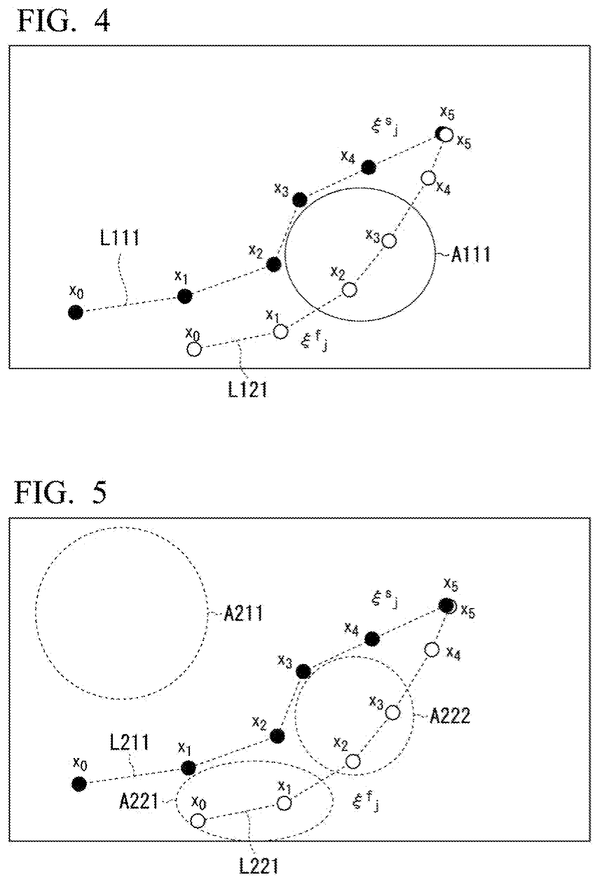

FIG. 3 shows an example of data input/output in the control system 1.

In the example in FIG. 3, the time-series data acquisition portion 181 acquires the training data ξ acquired using the actual machine of the control target 30. As described above for the constraint condition acquisition device 10, the time-series data acquisition portion 181 may acquire the training data ξ from simulations of the operation of the control target 30.

As described above, the individual time-series data ξⱼ that constitute the training data & include the state xₜ and the input uₜ for each time-series data and each time. Here, the two-dimensional coordinate representation of the position of the distal end portion of the robot arm as an example of the control target 30 is used as state xₜ, and the two-dimensional coordinate representation of the movement command value of the distal end portion of the robot arm between time steps is used as input uₜ.

FIG. 4 shows an example of the operation of the control target 30. In the example in FIG. 4, line L111 shows the trajectory of the distal end portion of the robot arm when the task is successful, and line L121 shows the trajectory of the distal end portion of the robot arm when the task fails.

On line L111, the distal end positions of the robot arm are plotted as states x₀ to x₅ included in the success time-series data ξⱼ^{s}. State x₀ indicates the start position of the movement of the distal end portion of the robot arm, and state x₅ indicates the end position of the movement.

On line L121, the distal end positions of the robot arm are plotted as states x₀ to x₅ included in the failure time-series data ξⱼ^{f}. State x₀ indicates the start position of the movement of the distal end portion of the robot arm, and state x₅ indicates the end position of the movement. In the task execution shown in line L121, the distal end portion of the robot arm starts its movement from a different position than in the task execution shown in line L111 and ends its movement at the same position as in the task execution shown in line L111.

Also shown in FIG. 4 is the area A111 where the distal end portion of the robot arm should avoid entry in order for the control system 1 to succeed in its task. The following is an example of a task in which a robot arm grasps and carries a package. If the distal end portion of the robot arm encroaches into the predetermined area illustrated in area A111, the control system 1 shall fail the task, for example, because the luggage contacts an obstacle and the robot arm drops the luggage.

When using the two-dimensional coordinates of the distal end portion of the robot arm as the control target 30 as the state shown in the time-series data ξⱼ, the state xₜ at time t can be expressed as in Expression (4).

$$\begin{matrix}[ Expression 4 ] & \\ {x}_{t} = [ {x}_{{t}_{1}} ; {x}_{{t}_{2}} ] & ( 4 )\end{matrix}$$

The coordinate axes of the two-dimensional coordinate system are referred to here as the first and second axes.

xₜ₁ and xₜ₂ indicate the coordinate values in the first and second axes, respectively.

The “;” denotes column vector notation. That is, “;” indicates that the elements of the vector are arranged vertically to denote a vector.

If the input (command value) to the control target 30 is expressed as a command value of the amount of state change between time steps, the input at time t can be expressed as in Expression (5).

$$\begin{matrix}[ Expression 5 ] & \\ {u}_{t} = [ {u}_{{t}_{1}} ; {u}_{{t}_{2}} ] & ( 5 )\end{matrix}$$

uₜ₁ and uₜ₂ indicate the amount of change in the coordinate values on the first and second axes, respectively.

The constraint condition estimation portion 182 estimates the constraint condition in the control of the control target 30 based on the training data ξ. Specifically, the constraint condition estimation portion 182 sets the constraint condition so that the constraint condition holds for the success time-series data ξⱼ^{s} and does not hold for the failure time-series data ξⱼ^{f}. The control device 20 is expected to succeed in the task by controlling the control target 30 so that the constraint condition holds.

Assume that there are known equality constraint conditions, known inequality constraint conditions, and unknown inequality constraint conditions in the control of the control target 30.

A known equality constraint condition can be expressed as in Expression (6).

$$\begin{matrix}[ Expression 6 ] & \\ {h}_{i , k} ( {ξ}_{j} ) = 0 , i = 1 , … , {N}_{k}^{e q} & ( 6 )\end{matrix}$$

Nₖ^{eq} indicates the number of known equality constraint conditions. In Expression (6), i denotes an identification number that identifies a known equality constraint condition.

h_{i, k} is the function that constitutes the equation. ξⱼ denotes the time-series data for one task execution. The equality constraint condition h_{i, k}(ξⱼ)=0 indicates the necessary conditions that must be satisfied to accomplish the task in an individual task execution.

The “i” in “h_{i, k}” indicates the above identification number. “k” indicates that the equality constraint condition hᵢ is known.

The Nₖ^{eq} constraint condition shown in Expression (6) can be expressed as in Expression (7) using vectors.

$$\begin{matrix}[ Expression 7 ] & \\ {h}_{k} ( {ξ}_{j} ) = 0 & ( 7 )\end{matrix}$$

hₖ(ξⱼ) is a vector whose elements are h_{1, k}(ξⱼ), . . . , h_{Nkeq, k}(ξⱼ), and is represented by a column vector as in Expression (8).

$$\begin{matrix}[ Expression 8 ] & \\ {h}_{k} ( {ξ}_{j} ) = [ {h}_{1 , k} ( {ξ}_{j} ) , … , {h}_{{N}_{k}^{e q} , k} ( {ξ}_{j} ) ] T & ( 8 )\end{matrix}$$

The “0” on the right side of Expression (7) is a column vector with an element value of 0. Expression (7) shows the constraint condition that the value of each element of hₖ(ξⱼ) is 0.

The “k” in “hₖ” also indicates that the equality constraint condition h is known.

A known inequality constraint condition can be expressed as in Expression (9).

$$\begin{matrix}[ Expression 9 ] & \\ {g}_{i , k} ( {ξ}_{j} ) \leq 0 , i = 1 , … , {N}_{k}^{i n e q} ) & ( 9 )\end{matrix}$$

Nₖ^{ineq} indicates the number of known inequality constraint conditions. In Expression (9), i denotes an identification number that identifies a known inequality constraint condition.

g_{i, k} is a function that constitutes an inequality. ξⱼ denotes the time-series data for one task execution. The inequality constraint condition g_{i, k}(ξⱼ)≤0 indicates the necessary conditions that must be satisfied to achieve the task in an individual task execution.

The “i” in “g_{i, k}” indicates the above identification number. “k” indicates that the inequality constraint condition gᵢ is known.

The Nₖ^{ineq} constraint condition shown in Expression (9) can be expressed as in Expression (10) using vectors.

$$\begin{matrix}[ Expression 10 ] & \\ {g}_{k} ( {ξ}_{j} ) \leq 0 & ( 10 )\end{matrix}$$

gₖ(ξⱼ) is a vector whose elements are g_{1, k}(ξⱼ), . . . , g_{Nkineq, k}(ξⱼ), and is represented by a column vector as in the case of “hₖ(ξⱼ)” in Expression (7).

The “0” on the right side of Expression (10) is a column vector with an element value of 0. Expression (10) indicates the constraint condition that the value of each element of gₖ(ξⱼ) is less than or equal to 0.

“k” in “gₖ” also indicates that the inequality constraint condition g is known.

An unknown inequality constraint condition can be expressed as in Expression (11)

$$\begin{matrix}[ Expression 11 ] & \\ {g}_{i , u k} ( {ξ}_{j} , θ ) \leq 0 , i = 1 , … , {N}_{u k}^{i n e q} & ( 11 )\end{matrix}$$

Nᵤₖ^{ineq} indicates the number of unknown inequality constraint conditions. In Expression (11), i denotes an identification number that identifies an unknown inequality constraint condition.

g_{i, uk} is a function that constitutes an inequality. ξⱼ denotes the time-series data for one task execution.

Since g_{i, uk} is a function constituting an unknown inequality, it is shown in the form of a template equipped with a parameter θ. The parameter θ may be indicated by a vector. In other words, multiple vector element values may be set as the value of the parameter θ.

The constraint condition acquisition device 10, for example, stores multiple templates of unknown inequality constraint conditions. Then, the constraint condition acquisition device 10 selects any of several templates and sets the value of the parameter θ according to the acquired training data ξ.

The inequality constraint condition g_{i, uk}(ξⱼ, θ)≤0 in which the value of the parameter θ is set indicates the necessary condition that must be satisfied to achieve the task in task execution. The constraint condition acquisition device 10 may repeatedly perform template selection and set parameter values to generate a plurality of unknown inequality constraint conditions, depending on the operating environment and known constraint conditions of the control target 30. As above, the number of unknown inequality constraint conditions is denoted as Nᵤₖ^{ineq}.

If the constraint condition acquisition device 10 sets different values for the parameter θ for the same type of template, each shall be treated as a separate constraint condition.

The “i” in “g_{i, uk}” indicates the above identification number. “uk” indicates that the inequality constraint condition gᵢ is unknown.

The Nᵤₖ^{ineq} constraint condition shown in Expression (11) can be expressed as in Expression (12) using a vector.

$$\begin{matrix}[ Expression 12 ] & \\ {g}_{u k} ( {ξ}_{j} , θ ) \leq 0 & ( 12 )\end{matrix}$$

gᵤₖ(ξⱼ, θ) is a vector whose elements are g_{1, k}(ξⱼ, θ), . . . , g_{Nukineq, uk}(ξⱼ, θ) and is represented by a column vector as in the case of “hₖ(ξⱼ)” in Expression (7).

The “0” on the right side of Expression (12) is a column vector with an element value of 0. Expression (12) shows the constraint condition that the value of each element of gᵤₖ(ξⱼ, θ) is less than or equal to 0.

The “uk” in “gᵤₖ” also indicates that the inequality constraint condition g is unknown.

See FIG. 4 for an example of a constraint condition.

When input uₜ is expressed as a command value of the state change amount between time steps as described above, the relationship between the input to the control target 30 and the state change is expressed as in Expression (13).

$$\begin{matrix}[ Expression 13 ] & \\ {x}_{t + 1} = {x}_{t} + {u}_{t} & ( 13 )\end{matrix}$$

Expression (13) represents that the state change from state xₜ at time t to state xₜ₊₁ at time t+1 in response to input uₜ.

Expression (13) corresponds to an example of a known equality constraint condition.

It is also conceivable that the specifications of the control target 30 and other factors may define upper and lower limits for the input values to the control target 30. For example, the upper limit value u_{ineq} and lower limit value −u_{ineq} shown in Expression (14) may be specified according to the dynamic characteristics of the control target 30 as the upper and lower limits of the input uₜᵢ (i=1, 2) in Expression (5), which indicates the amount of change in coordinate values for each coordinate axis.

$$\begin{matrix}[ Expression 14 ] & \\ - {u}_{i n e q} \leq {u}_{{t}_{i}} \leq {u}_{i n e q} & ( 14 )\end{matrix}$$

u_{ineq} is a positive real constant.

The inequalities “−u_{ineq}≤uₜᵢ” and “uₜᵢ≤u_{ineq}” in Expression (14) for the case i=1 and i=2, respectively, are examples of known inequality constraint conditions.

The constraint condition that the control target 30 does not enter area A111 can be expressed as in Expression (15).

$$\begin{matrix}[ Expression 15 ] & \\ 1 - \frac{{( {x}_{{t}_{1}} - {x}_{c} )}^{2}}{{a}^{2}} - \frac{{( {x}_{{t}_{2}} - {y}_{c} )}^{2}}{{b}^{2}} \leq 0 & ( 15 )\end{matrix}$$

x_{c} and y_{c} indicate the center coordinates when the area A111 is assumed to be an elliptical area. x_{c} indicates the coordinate value of the first axis, while y_{c} indicates the coordinate value of the second axis. a and b indicate the major diameter and minor diameter of the ellipse. Either of a and b may indicate the major diameter. Also, a=b may be used, in which case the area A111 is represented as a circular area.

In Expression (15), for example, each of “x_{c}”, “y_{c}”, “a²” and “b²” can be treated as a parameter. In this case, the vector of parameter θ can be expressed as in Expression (16).

$$\begin{matrix}[ Expression 16 ] & \\ θ = [ {a}^{2} , {b}^{2} , {x}_{c} , {y}_{c} ] & ( 16 )\end{matrix}$$

Expression (15) with the values of each parameter undefined corresponds to an example of an unknown inequality constraint condition template. Expression (15) with the values of each parameter fixed corresponds to an example of an unknown inequality constraint condition.

The template acquisition portion 183 selects any of the templates stored by the template storage portion 171, and the constraint condition calculation portion 186 sets the parameter values of the template to obtain the unknown inequality constraint condition.

In the constraint condition estimation portion 182, the template acquisition portion 183 selects any of the constraint condition templates stored by the template storage portion 171 based on the training data.

As described above, the template acquisition portion 183 judges as non-conforming and excludes from acquisition a constraint condition template in which no parameter values exist such that the constraint condition is satisfied in the success time-series data and the constraint condition is not satisfied in the failure time-series data.

The fact that the constraint condition holds in the success time-series data is expressed as in Expression (17), where the time-series data ξⱼ in Expression (12) serves as the success time-series data ξⱼ^{s}.

$$\begin{matrix}[ Expression 17 ] & \\ {g}_{u k} ( {ξ}_{j}^{s} , θ ) \leq 0 & ( 17 )\end{matrix}$$

The fact that the constraint condition does not hold in the failure time-series data is expressed as in Expression (18), where the inequality symbol “≤” in Expression (12) is replaced by “>”, and the time-series data ξⱼ serves as the failure time-series data ξⱼ^{f}.

$$\begin{matrix}[ Expression 18 ] & \\ {g}_{u k} ( {ξ}_{j}^{f} , θ ) > 0 & ( 18 )\end{matrix}$$

The template acquisition portion 183 selects one or more constraint condition templates for which there exist values of the parameter θ such that Expression (17) holds for all times of all success time-series data ξⱼ^{s} and Expression (18) holds for one or more times of one or more failure time-series data ξⱼ^{f}.

On the other hand, the template acquisition portion 183 excludes from selection in advance the constraint condition templates in which no values of the parameter θ exist such that Expression (17) holds for all times of all success time-series data ξⱼ^{s} and Expression (18) holds for one or more times of one or more failure time-series data ξⱼ^{f}.

FIG. 5 is a diagram showing an example of the relationship between time-series data and the areas set as unknown inequality constraints. In the example in FIG. 5 is shown line L211 showing the trajectory of the distal end portion of the robot arm when the task is successful, and line L221 showing the trajectory of the distal end portion of the robot arm when the task fails. Line L211, and states x₀ to x₅ plotted on line L211, are the same as line L111, and states x₀ to x₅ plotted on line L111 in FIG. 4. Line L221, and states x₀ to x₅ plotted on line L221, are similar to line L121, and states x₀ to x₅ plotted on line L121 in FIG. 4.

Also shown in FIG. 5 are areas A211, A221, and A222. None of the states included in the failure time-series data ξⱼ^{f} are included in area A211. On the other hand, states x₀ and x₁, among the states included in the failure time-series data ξⱼ^{f}, are included in the area A221. Also, states x₂ and x₃, among the states included in the failure time-series data ξⱼ^{f}, are included in the area A222.

Here, a constraint condition template is provided that represents an elliptical area as an area that the control target 30 cannot enter, with the diameter of the ellipse in the first coordinate axis direction and the diameter of the ellipse in the second coordinate axis direction serving as the parameters. On the other hand, the coordinates of the center point of the ellipse shall be predetermined in the constraint condition template. The template acquisition portion 183 selects a constraint condition template with appropriate coordinates according to the training data from among multiple constraint condition templates with different coordinates.

As shown above, the states x₀ and x₁ are included in the area A221 among the states included in the failure time-series data ξⱼ^{f}. Therefore, by setting the inequality constraint condition so that the condition holds outside of the area A221 and the condition does not hold inside of the area A221, the constraint condition holds for the success time-series data ξⱼ^{s} and not for the failure time-series data ξⱼ^{f}.

Also, the states x₂ and x₃ are included in the area A222 among the states included in the failure time-series data ξⱼ^{f}. Therefore, by setting the inequality constraint condition so that the condition holds outside of the area A222 and the condition does not hold inside of the area A222, the constraint condition holds for the success time-series data ξⱼ^{s} and not for the failure time-series data ξⱼ^{f}.

Accordingly, the template acquisition portion 183 can select either one or both of the constraint condition template indicating the area A221 or the constraint condition template indicating the area A222.

On the other hand, none of the states included in the failure time-series data ξⱼ^{f} are included in the area A211. Even if the diameter of the ellipse is changed by changing the parameter value of the constraint condition template indicating the area A211, the states included in the success time-series data are first included in the area A211, and it is not possible to make only the states included in the failure time-series data be included in the area A211.

Thus, in the constraint condition template showing the area A211, there are no parameter values for which the constraint condition holds in the success time-series data and does not hold in the failure time-series data.

Therefore, the template acquisition portion 183 excludes the constraint condition template indicating the area A211 from the candidates for selection and does not select it.

When selecting a constraint condition template, the template acquisition portion 183 may set a range of possible values for the parameter. For example, when selecting a constraint condition template indicating the area A221, the template acquisition portion 183 may calculate a range of parameter values in which at least one of the states x₂ or x₃ of the failure time-series data ξⱼ^{f} is included in the area A221, and none of the states of the success time-series data ξⱼ^{s} is included in the area A221. The constraint condition calculation portion 186, when solving the solution search problem and calculating parameter values, need only search within the range of parameter values calculated by the template acquisition portion 183, and in this respect, the load on the constraint condition calculation portion 186 can be reduced.

The template acquisition portion 183 may further select a constraint condition template based on any of the control parameter information, cost functions, or known constraint conditions, or a combination thereof, stored by the configured information storage portion 172.

For example, the template acquisition portion 183 may exclude a constraint condition template that indicates a constraint condition encompassed by known constraint conditions from selection and select another constraint condition template. The template acquisition portion 183 may exclude a constraint condition template that indicates a constraint condition that does not affect the optimization of the cost function from the selection and select another constraint condition template.

The problem setting portion 184 sets a solution search problem for calculating the parameter value of the constraint condition template based on the configured information stored by the configured information storage portion 172 and the constraint condition template acquired by the template acquisition portion 183. In doing so, the problem setting portion 184 determines the framework for the solution search problem based on the framework information stored by the framework information storage portion 173.

The expression format of the constraint conditions in the control system 1 is not limited to a specific format, and various expression formats can be used in which some of the constraint conditions can be expressed by inequalities.

The following is an example of a case where the constraint condition is expressed as a KKT condition (Karush-Kuhn-Tucker condition).

The main constraint condition of the KKT condition (the feasibility condition of the main problem) for the time-series data ξⱼ can be expressed as in Expression (19).

$$\begin{matrix}[ Expression 19 ] & \\ \{ \begin{matrix}{h}_{k} ( {ξ}_{j} ) = 0 , \\ {g}_{k} ( {ξ}_{j} ) \leq 0 , \\ {g}_{u k} ( {ξ}_{j}^{s} , θ ) \leq 0 , \\ {g}_{u k} ( {ξ}_{j}^{f} , θ ) > 0\end{matrix} & ( 19 )\end{matrix}$$

“hₖ(ξⱼ)=0” indicates a known equality constraint condition, as explained with reference to Expression (7).

“gₖ(ξⱼ)≤0” indicates a known inequality constraint condition, as explained with reference to Expression (10).

“gᵤₖ(ξⱼ^{s}, θ)≤0” and “gᵤₖ(ξⱼ^{f}, θ)>0” are both unknown inequality constraint conditions. As mentioned above, the time-series data ξⱼ acquired by the constraint condition acquisition device 10 is tied to information indicating whether the task succeeded or failed. Expression (19) distinguishes between the time-series data ξⱼ^{s} in the case of task success and the time-series data ξⱼ^{f} in the case of task failure.

In the case of task success, “gᵤₖ(ξⱼ^{s}, θ)≤0” is an expression substituting “ξⱼ^{s}” for “ξⱼ” in Expression (12).

On the other hand, “gᵤₖ(ξⱼ^{f}, θ)>0” in the case of task failure expresses the condition that the condition “gᵤₖ(ξⱼ, θ)≤0” shown in Expression (12) does not hold. Taking the contraposition of the proposition “the condition gᵤₖ(ξⱼ, θ)≤0 does not hold in the case of task failure”, “if the condition gᵤₖ(ξⱼ, θ)≤0 holds, it is a case of task success”.

Therefore, the constraint condition acquisition device 10 may set the constraint conditions based on Expression (19), and the control device 20 may control the control target 30 to satisfy the constraint conditions, including the unknown inequality constraint condition shown in Expression (12). This allows the control device 20 to control the control target 30 in such a way that it avoids failing the task with “gᵤₖ(ξⱼ, θ)>0” and is expected to accomplish the task.

The main constraint condition shown in Expression (19) is also denoted as “Condition A”.

The Lagrange multiplier in the KKT condition is denoted by the vectors λₖ and λᵤₖ. The Lagrange multiplier is also referred to as the KKT multiplier.

The condition that the Lagrange multiplier takes a value greater than or equal to 0 (a feasibility condition for the dual problem) is expressed as in Expression (20).

$$\begin{matrix}[ Expression 20 ] & \\ \{ \begin{matrix}{λ}_{k} \geq 0 \\ {λ}_{uk} \geq 0\end{matrix} & ( 20 )\end{matrix}$$

The vector λₖ is expressed as in Expression (21).

$$\begin{matrix}[ Expression 21 ] & \\ {λ}_{k} = {[ {λ}_{1 , k} , … , {λ}_{{N}_{k}^{ineq} , k} ]}^{T} & ( 21 )\end{matrix}$$

λ_{i, k}(i=1, . . . , Nₖ^{ineq}) denotes the Lagrange multiplier for each known inequality constraint “gₖ(ξⱼ)≤0”.

As in the case of “hₖ(ξⱼ)” in Expression (7), in Expression (21), λₖ is represented by a column vector. “λₖ≥0” in Expression (20) indicates the constraint that the value of each element of λₖ is greater than or equal to 0.

The vector λᵤₖ is expressed as in Expression (22).

$$\begin{matrix}[ Expression 22 ] & \\ {λ}_{uk} = {[ {λ}_{1 , uk} , … , {λ}_{{N}_{uk}^{ineq} , uk} ]}^{T} & ( 22 )\end{matrix}$$

λ_{i, uk} (i=1, . . . , Nᵤₖ^{ineq}) denotes the Lagrange multiplier for each unknown inequality constraint “gᵤₖ(ξⱼ, θ)≤0”.

As in the case of “hₖ(ξⱼ)” in Expression (7), in Expression (22), λᵤₖ is represented by a column vector. “λᵤₖ≥0” in Expression (20) indicates the constraint condition that the value of each element of λᵤₖ is greater than or equal to 0.

The constraint condition on the Lagrange multiplier shown in Expression (20) is also denoted as “Condition B”.

The complementary slack condition (condition relating to the slack variable) in the KKT condition is expressed as in Expression (23).

$$\begin{matrix}[ Expression 23 ] & \\ \{ \begin{matrix}{λ}_{k} ∘ {g}_{k} ( {ξ}_{j}^{s} ) = 0 \\ {λ}_{uk} ∘ {g}_{u k} ( {ξ}_{j}^{s} , θ ) = 0\end{matrix} & ( 23 )\end{matrix}$$

The operator indicated by a circle (∘) represents the Adamar product, i.e., the element-by-element (component-by-component) product of a matrix or vector. The upper equality “λₖ∘gₖ(ξⱼ^{s})=0” in Expression (23) indicates the constraint condition that the value of the element-by-element product of “λₖ” and “gₖ(ξⱼ^{s})” is 0. The lower equality “λᵤₖ∘gᵤₖ(ξⱼ^{s}, θ)=0” in Expression (23) indicates the constraint condition that the value of any element-by-element product of “λᵤₖ” and “gᵤₖ(ξⱼ^{s}, θ)” is 0.

The complementary slack condition shown in Expression (23) is also denoted as “Condition C”.

The stationarity condition in the KKT condition is shown in Expression (24).

$$\begin{matrix}[ Expression 24 ] & \\ {∇}_{{ξ}_{j}^{s}} c ( {ξ}_{j}^{s} ) + {λ}_{k}^{j} {}^{T} {∇}_{{ξ}_{j}^{s}} {g}_{k} ( {ξ}_{j}^{s} ) + {λ}_{u k}^{j} {}^{T} {∇}_{{ξ}_{j}^{s}} {g}_{u k} ( {ξ}_{j}^{s} ) + {v}_{k}^{j} {}^{T} {∇}_{{ξ}_{j}^{s}} {h}_{k} ( {ξ}_{j}^{s} ) = 0 & ( 24 )\end{matrix}$$

∇ denotes the nabla operator.

c represents the cost function.

vₖ^{j} denotes the Lagrange multiplier corresponding to the equality constraint condition hₖ(ξⱼ).

The stationarity condition shown in Expression (24) is also denoted as “Condition D”.

As the cost function c, that shown for example in Expression (25) can be used.

$$\begin{matrix}[ Expression 25 ] & \\ c = {\sum }_{t} ( {‖ {x}_{t + 1} - {x}_{d} ‖}_{R}^{2} + {‖ {u}_{t} ‖}_{Q}^{2} ) & ( 25 )\end{matrix}$$

x_{d} represents the attainment target position of the distal end portion of the robot arm. In the example in FIG. 4, the attainment target position is represented by a point in state x₅, where x_{d}=x₅.

R and Q denote regular matrices, respectively.

“∥xₜ₊₁−x_{d}|_{R}²” is expressed as in Expression (26).

$$\begin{matrix}[ Expression 26 ] & \\ {‖ {x}_{t + 1} - {x}_{d} ‖}_{R}^{2} = {( {x}_{t + 1} - {x}_{d} )}^{T} R ( {x}_{t + 1} - {x}_{d} ) & ( 26 )\end{matrix}$$

In “|xₜ₊₁−x_{d}|_{R}²”, the closer the position of the control target 30 is to the attainment target position, the smaller the cost.

“∥uₜ|_{Q}²” is expressed as in Expression (27).

$$\begin{matrix}[ Expression 27 ] & \\ {‖ {u}_{t} ‖}_{R}^{2} = {u}_{t}^{T} Q {u}_{t} & ( 27 )\end{matrix}$$

In “|xₜ₊₁−x_{d}|_{R}²”, the smaller the amount of movement of the control target 30, the smaller the cost.

When the constraint condition is expressed as a KKT condition as described above, as a first example of a framework constituting a solution search problem, it is possible to use a framework in which Condition A, Condition B, Condition C, and Condition D are all assigned to constraint conditions in the solution search problem. In this case, the solution search problem is presented as in Expression (28).

$$\begin{matrix}[ Expression 28 ] & \\ \{ \begin{matrix}Find θ , {λ}_{k} , {λ}_{uk} , {ν}_{k} \\ \begin{matrix}subject to Codition A ( {ξ}_{j} ) , Condition B ( {ξ}_{j} ) , \\ Condition C ( {ξ}_{j} ) , Condition D ( {ξ}_{j} ) ,\end{matrix} \\ ∀ {ξ}_{j} , j = 1 , … , {N}_{s}\end{matrix} & ( 28 )\end{matrix}$$

Expression (28) searches for a combination of parameter θ, Lagrange multiplier vectors λₖ, λᵤₖ, and vₖ^{j} such that the main constraint condition shown in Expression (19), the Lagrange multiplier constraint condition shown in Expression (20), the complementary slack condition shown in Expression (23), and the stationarity condition shown in Expression (24) are all satisfied.

The solution search problem shown in Expression (28) is also denoted as “Problem 1”.

As a second example of a framework constituting a solution search problem, it is possible to use a framework that assigns Condition A, Condition B, and Condition C to a constraint condition in the solution search problem, and assigns Condition D to the objective function. In this case, the solution search problem is presented as in Expression (29).

$$\begin{matrix}[ Expression 29 ] & \\ \{ \begin{matrix}{arg min}_{θ , {λ}_{k} , {λ}_{uk} , {ν}_{k}} {\sum }_{j = 1}^{{N}_{s}} ( ‖ Condition D ( {ξ}_{j} ) ‖ ) \\ subject to Codition A ( {ξ}_{j} ) , Condition B ( {ξ}_{j} ) , Condition C ( {ξ}_{j} ) , \\ ∀ {ξ}_{j} , j = 1 , … , {N}_{s}\end{matrix} & ( 29 )\end{matrix}$$

In Expression (29), the main constraint condition shown in Expression (19), the Lagrange multiplier constraint condition in Expression (20), and the complementary slack condition in Expression (23) are used as constraint conditions in the optimization problem to solve the optimization problem of finding a combination of parameter θ and Lagrange multiplier vectors λₖ, λᵤₖ, and vₖ^{j} such that the magnitude of the left-hand side of Expression (24) is as small as possible.

The objective function “∥Condition D(ξⱼ)∥” in Expression (29) indicates the norm on the left side of Expression (24).

The solution search problem shown in Expression (29) is also denoted as “Problem 2”.

Comparing Expression (28) with Expression (29), Expression (28) requires that the value on the left side of Expression (24) be 0. In contrast, Expression (29) does not require that the value on the left side of Expression (24) be strictly 0, and the magnitude of the value on the left side of Expression (24) is minimized.

In this respect, Expression (29) is a more relaxed condition than Expression (28). Expression (28) is more accurate in obtaining the constraint condition to accomplish the task, while Expression (29) is easier to solve.

The computational complexity is also expected to be less for Expression (29) than for Expression (28).

For example, one might try solving the optimization problem in Expression (28), and if the solution cannot be obtained within a given time, one might try solving the optimization problem in Expression (29).

As a third example of a framework constituting a solution search problem, it is possible to use the framework that assigns Condition A, Condition B, and Condition D to a constraint condition in the solution search problem, and assigns Condition C to the objective function. The solution search problem in this case is as presented in Expression (30).

$$\begin{matrix}[ Expression 30 ] & \\ \{ \begin{matrix}{arg min}_{θ , {λ}_{k} , {λ}_{uk} , {ν}_{k}} {\sum }_{j = 1}^{{N}_{s}} ( ‖ Condition C ( {ξ}_{j} ) ‖ ) \\ subject to Codition A ( {ξ}_{j} ) , Condition B ( {ξ}_{j} ) , Condition D ( {ξ}_{j} ) , \\ ∀ {ξ}_{j} , j = 1 , … , {N}_{s}\end{matrix} & ( 30 )\end{matrix}$$

In Expression (30), the main constraint condition shown in Expression (19), the Lagrange multiplier constraint condition in Expression (20), and the stationarity condition in Expression (24) are used as constraint conditions in the optimization problem to solve the optimization problem of finding a combination of parameter θ and Lagrange multiplier vectors λₖ, λᵤₖ, and vₖ^{j} such that the magnitude of the left-hand side of Expression (23) is as small as possible.

In this case, the two vectors “λₖ∘gₖ(ξⱼ^{s})” and “λuk∘gᵤₖ(ξⱼ^{s}, θ)” are obtained as the left side of Expression (23). The objective function “∥Condition D(ξⱼ)∥” in Expression (30) represents the sum of the norms of these two vectors.

The solution search problem shown in Expression (30) is also denoted as “Problem 3”.

Comparing Expression (29) with Expression (30), Expression (30) is expected to be easier to solve in that the complementary slack condition shown in Expression (23) is not used as a constraint condition in the optimization problem. Here, constraint conditions in the form of Condition C are difficult to handle as constraint conditions in optimization problems, and it can be said that they are difficult to optimize (difficult to obtain a solution). In contrast, in Expression (30), Condition C is no longer set as an optimal function by being made an objective function. In this respect, the case of Expression (30) is expected to be easier to solve than the case of Expression (29).

Regarding the accuracy of the solution, Expression (29), which uses the complementary slack condition shown in Expression (23) as a constraint condition in the optimization problem, is expected to be more accurate when a solution is obtained.

For example, one might try solving the optimization problem in Expression (29), and if the solution cannot be obtained within a predetermined time, one might try solving the optimization problem in Expression (30).

As a fourth example of a framework constituting a solution search problem, it is possible to use the framework that assigns Condition A and Condition B to a constraint condition in the solution search problem, and assigns Condition C and Condition D to the objective function. In this case, the solution search problem is presented as in Expression (31).

$$\begin{matrix}[ Expression 31 ] & \\ \{ \begin{matrix}{arg min}_{θ , {λ}_{k} , {λ}_{uk} , {ν}_{k}} {\sum }_{j = 1}^{{N}_{s}} ( ‖ Condition C ( {ξ}_{j} ) ‖ + ‖ Condition D ( {ξ}_{j} ) ‖ ) \\ subject to Codition A ( {ξ}_{j} ) , Condition B ( {ξ}_{j} ) , \\ ∀ {ξ}_{j} , j = 1 , … , {N}_{s}\end{matrix} & ( 31 )\end{matrix}$$

In Expression (31), the main constraint condition shown in Expression (19) and the Lagrange multiplier constraint condition shown in Expression (20) are used as constraint conditions in the optimization problem to solve the optimization problem of finding a combination of parameter θ and Lagrange multiplier vectors λₖ, λᵤₖ, and vₖ^{j} such that the total of the magnitude of the left-hand side of Expression (23) and the magnitude of the left-hand side of Expression (24) is as small as possible.

The objective function “∥Condition C(ξⱼ)∥” in Expression (31) is the same as in Expression (30). “∥Condition D(ξⱼ)∥” is the same as in Expression (29).

The solution search problem shown in Expression (31) is also denoted as “Problem 4”.

In Expression (31), the condition can be said to be even more relaxed than in Expressions (29) and (30). Expression (29) or Expression (30) is more accurate in obtaining the constraint condition to accomplish the task, while Expression (31) is easier to solve.

It is also expected that Expression (31) will be less computationally intensive than either Expression (29) or Expression (30).

For example, one might try solving with Expression (29) or Expression (30), and if the solution cannot be obtained within a predetermined time, one might try solving with Expression (31).

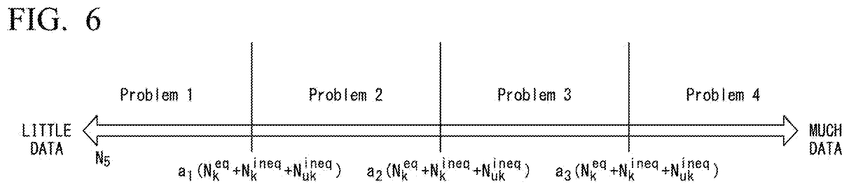

FIG. 6 is a diagram showing an example of the selection criteria for the framework of a solution search problem. In the example in FIG. 6, the problem setting portion 184 compares three threshold values obtained by multiplying the sum of the number of known equality constraints Nₖ^{eq}, the number of known inequality constraints Nₖ^{ineq}, and the number of unknown inequality constraints Nₖ^{ineq} by the coefficients a₁, a₂, and a₃, respectively, with the number of time-series data Nₛ to determine the solution search problem to be generated. The magnitudes of the coefficients are 0<a₁<a₂<a₃.

If Nₛ≤a₁(Nₖ^{eq}+Nₖ^{ineq}+Nᵤₖ^{ineq}), the problem setting portion 184 generates the solution search problem “Problem 1”.

If a₁(Nₖ^{eq}+Nₖ^{ineq}+Nᵤₖ^{ineq})<Nₛ≤a₂(Nₖ^{eq}+Nₖ^{ineq}+Nᵤₖ^{ineq}), the problem setting portion 184 generates the solution search problem “Problem 2”.

If a₂(Nₖ^{eq}+Nₖ^{ineq}+Nᵤₖ^{ineq})<Nₛ≤a₃(Nₖ^{eq}+Nₖ^{ineq}+Nᵤₖ^{ineq}), the problem setting portion 184 generates the solution search problem “Problem 3”.

If a₃(Nₖ^{eq}+Nₖ^{ineq}+Nᵤₖ^{ineq})<Nₛ, the problem setting portion 184 generates the solution search problem “Problem 4”.

Thus, the problem setting portion 184 may generate a solution search problem using a less computationally intensive framework as the number of constraint conditions in control increases.

If the generated solution search problem does not yield the parameter values of the constraint condition template, the problem setting portion 184 may re-generate a solution search problem that is less computationally demanding.

When the problem setting portion 184 generates a solution search problem, the integration portion 185 may perform either or both of data integration or constraint condition integration.

The integration portion 185 performs integration of constraint conditions used in the solution search problem using a function that outputs an approximation of the maximum value of the argument. A function that outputs an approximation of the maximum value of an argument is called a maximum value approximation function and is denoted as “max^{˜}”.

A function that outputs the maximum value of an argument is called a maximum value function and is denoted max. In either of the maximum value function max and maximum value approximation function max^{˜}, if the argument is a vector, the maximum value or approximation thereof shall be obtained for each element of the vector.

The maximum value approximation function max^{˜} may be defined as in Expression (32).

$$\begin{matrix}[ Expression 32 ] & \\ {max}^{∼} \{ {a}_{1} , … , {a}_{m} \} = ( {a}_{1} {e}^{β {a}_{1}} + … + {a}_{m} {e}^{β {a}_{m}} ) / ( {e}^{β {a}_{1}} + … + {e}^{β {a}_{m}} ) & ( 32 )\end{matrix}$$

e denotes Napier's number.

β is a constant such that β≥1 and should preferably be as large a number as possible.

In the case of the definition shown in Expression (32), max (a)>max^{˜}(a).

Alternatively, the maximum value approximation function max^{˜} may be defined as in Expression (33).

$$\begin{matrix}[ Expression 33 ] & \\ {max}^{∼} \{ {a}_{1} , … , {a}_{m} \} = \frac{1}{β} ln ( {a}_{1} {e}^{β {a}_{1}} + … + {a}_{m} {e}^{β {a}_{m}} ) & ( 33 )\end{matrix}$$

e and β are the same as in Expression (32).

For the definition shown in Expression (33), max (a)<max^{˜}(a).

In both the case of the definition shown in Expression (32) and the case of the definition shown in Expression (33), the maximum value approximation function max^{˜} is a smooth function. In particular, in any case the maximum value approximation function max^{˜} is differentiable. Using a differentiable function in this way allows solution search using gradients, and the computational complexity of the solution search is relatively small. It is also expected that solutions can be obtained for problems of large scale.

Depending on the orientation of the inequality in the inequality constraint condition, the integration portion 185 may use a minimum value approximation function in addition to, or instead of, the maximum value approximation function described above to perform either or both of the data integration or constraint condition integration.

The minimum value approximation function is a function that outputs an approximation of the minimum value of the argument and is defined as a smooth function, similar to the maximum value approximation function by the definition of Expression (32) or Expression (33) above. The minimum approximation function min^{˜} is defined, for example, as in Expression (34).

$$\begin{matrix}[ Expression 34 ] & \\ {min}^{∼} \{ {a}_{1} , … , {a}_{m} \} = - {max}^{∼} \{ - {a}_{1} , … , - {a}_{m} \} & ( 34 )\end{matrix}$$

The problem setting portion 184 sets a solution search problem to determine the parameter values of the constraint condition template. The constraint condition templates with parameter values are used as constraint conditions in the control of the control target 30.

As described above, the constraint condition acquisition device 10 sets constraint conditions in the control of the control target 30 so that the constraint conditions hold in the success time-series data and do not hold in the failure time-series data. The setting of constraint conditions in the control of the control target 30 is performed by the constraint condition calculation portion 186, which determines the parameter values of the constraint condition template using the solution search problem generated by the problem setting portion 184.

Therefore, the problem setting portion 184 generates a solution search problem by using the equation obtained by inputting time-series data into the constraint conditions in the control of the control target 30 as the constraint condition or objective function in the solution search problem.

For example, consider the number of constraint conditions in the solution search problem that are constructed using known inequality constraint conditions in “Problem 1” above, where no objective function is provided and all constraint conditions that are set are treated as constraint conditions in the solution search problem. In this case, each of the inequality constraint conditions g_{i, k}(ξⱼ)≤0, obtained by inputting each of the time-series data into each of the known inequality constraint conditions, is used as a constraint condition in the solution search problem. Therefore, the number of constraint conditions based on known inequality constraint conditions, among the constraint conditions in the solution search problem, is Nₖ^{ineq}× Nₛ, which is the number of known inequality constraints Nₖ^{ineq} multiplied by the number of time-series data Nₛ.

Similarly, for unknown inequality constraint conditions and known equality constraint conditions, the number of constraint conditions in the solution search problem can be the product of the number of constraint conditions and the number of time-series data, respectively.

In contrast, the integration portion 185 may integrate constraint conditions in the solution search problem for the time-series data.

The integration portion 185 may also integrate constraint conditions in the solution search problem with respect to the constraint condition in the control of the control target.

Alternatively, the integration portion 185 may integrate constraint problems in the solution search problem both with respect to the time-series data and with respect to the function that constitutes the constraint condition.

The integration of known inequality constraints for time-series data is expressed, for example, as in Expression (35).

$$\begin{matrix}[ Expression 35 ] & \\ {g}_{k} ( ξ ) ⇋ {{max}^{\sim}}_{j ∈ \{ 1 , … , {N}_{s} \}} {g}_{k} ( {ξ}_{j} ) ⇋ {{max}^{\sim}}_{j ∈ \{ 1 , … , {N}_{s} \}} \{ {{max}^{\sim}}_{j ∈ \{ 0 , … , Nt \}} {g}_{k} ( {p}_{j , i} ) \} & ( 35 )\end{matrix}$$

p_{j, i} denotes the time-series data corresponding to the constraint condition. In the case of a constraint condition corresponding to a state, the state vector x_{j, i} at time i of the j-th sample corresponds to p_{j, i}. In the case of a constraint condition on the input to the control target 30, the input vector u_{j, i} at time i of the j-th sample corresponds to p_{j, i}.

“gₖ(ξ)≈max^{˜}_{j={1, . . . , Nkineq}}gₖ(ξⱼ)” on the left-hand side of Expression (35) expresses representing the function g_{i, k}(ξ₁), . . . , g_{i, k}(ξ_{Ns}), of the functions g_{i, k}(ξⱼ) (i=1, . . . , Nₖ^{ineq}, j=1, . . . , Nₛ), which are elements of the vector gₖ(ξ) of functions constituting the inequality constraint condition, with the function max^{˜}_{j∈{1, . . . , Nkineq}}gₖ(ξⱼ) where among these Nₛ functions the function value is maximized.

“max^{˜}_{j∈{1, . . . , Nkineq}}gₖ(ξⱼ)≈max^{˜}_{j∈{1, . . . , Nkineq}}{max^{˜}_{i∈{0, . . . , Nt}}gₖ(p_{j, i})}” on the right- hand side of Expression (35) expresses representing the function value gₖ(ξⱼ) in a single time-series data with the maximum value max^{˜}_{i∈{0, . . . , Nt}}gₖ(p_{j, i}) of the function values in that time-series data.

Based on Expression (35), the integration portion 185 represents the value of the function gₖ(ξ) in the known inequality constraint condition by the maximum value max^{˜}_{j∈{1, . . . , Nkineq}}{max^{˜}_{i={0, . . . , Nt}}gₖ(p_{j, i})} of the function gₖ(ξ) for time-series data and time, and thereby integrates the constraint condition in the solution search problem with respect to time-series data.

In this case, the number of constraint conditions based on known inequality constraint conditions (the number of elements in the vector gₖ(ξⱼ)) among the constraint conditions in the solution search problem is Nₖ^{ineq}, the number of known inequality constraint conditions, which is reduced from Nₖ^{ineq}×Nₛ when the integration portion 185 does not integrate constraint conditions. The number of Lagrange multipliers corresponding to a decreasing number of constraint conditions can be reduced, thus reducing the computational cost of finding a solution to the solution search problem.

Taking the maximum value max^{˜}_{j∈{1, . . . , Nkineq}}{max^{˜}_{i|{0, . . . , Nt}}gₖ(p_{j, i})} in Expression (35) can be said to be representing with the time-series data that is closest to the boundary value of the constraint condition, i.e., the most critical time-series data for the constraint condition. The integration portion 185 approximates taking the maximum value by using a maximum value approximation function.

Integration for the function that constitutes the known inequality constraint condition is expressed as in Expression (36).

$$\begin{matrix}[ Expression 36 ] & \\ {g}_{k} ( ξ ) = {max}_{j ∈ \{ 1 , … , {N}_{k}^{ineq} \}} {g}_{j , k} ( {ξ}_{j} ) ⇋ {{max}^{\sim}}_{j ∈ \{ 1 , … , {N}_{k}^{ineq} \}} {g}_{j , k} ( {ξ}_{j} ) & ( 36 )\end{matrix}$$

The left-hand side of Expression (36), “gₖ(ξ)=max_{j∈{1, . . . , Nkineq}}g_{j, k}(ξⱼ),” indicates that the largest of Nₖ^{ineq} functions g_{j, k}(ξⱼ) is used as the function gₖ(ξ) for the known inequality constraint conditions. The right-hand side of Expression (36), “max_{j∈{1, . . . , Nkineq}}g_{j, k}(ξⱼ)≈max^{˜}_{j∈{1, . . . , Nkineq}}g_{j, k}(ξⱼ)” indicates that the maximum value approximation function max^{˜} is used instead of the maximum value function max.

As described above, the Nₖ^{ineq} known inequality constraint conditions in the control of the control target 30 are represented in the constraint conditions in the solution search problem by a single function that approximates the maximum value of those functions. As a result, the number of constraint conditions based on known inequality constraint conditions, among the constraint conditions in the solution search problem, is Nₛ data series, which is reduced from Nₖ^{ineq}×Nₛ when the integration portion 185 does not perform integration of constraint conditions. The number of Lagrange multipliers corresponding to a decreasing number of constraint conditions can be reduced, thus reducing the computational cost of finding a solution to the solution search problem.

The integration of unknown inequality constraints for time-series data is expressed, for example, as in Expression (37).

$$\begin{matrix}[ Expression 37 ] & \\ {g}_{uk} ( ξ , θ ) ⇋ {{max}^{\sim}}_{j ∈ \{ 1 , … , {N}_{s} \}} {g}_{uk} ( {ξ}_{j} , θ ) ⇋ {{max}^{\sim}}_{j ∈ \{ 1 , … , {N}_{s} \}} \{ {{max}^{\sim}}_{j ∈ \{ 0 , … , Nt \}} {g}_{uk} ( {p}_{j , i} , θ ) \} & ( 37 )\end{matrix}$$

At the time the integration portion 185 performs the calculation of Expression (37), the value of the parameter θ of the constraint condition template is undetermined. Therefore, the integration portion 185 calculates the function gᵤₖ(ξ, θ) with θ as an argument in the calculation of Expression (37).

Based on Expression (37), the integration portion 185 represents the value of the function gᵤₖ(ξ, θ) in the unknown inequality constraint condition by the maximum value max^{˜}_{j∈{1, . . . , Nukineq}}{max^{˜}_{i∈{0, . . . , Nt}}gᵤₖ(p_{j, i}, θ)} of the function gᵤₖ(ξ, θ) for time-series data and time, and thereby integrates the constraint condition in the solution search problem with respect to time-series data.

In this case, the number of constraint conditions based on unknown inequality constraint conditions (the number of elements in the vector gₖ(ξⱼ)) among the constraint conditions in the solution search problem is Nᵤₖ^{ineq}, the number of unknown inequality constraint conditions, which is reduced from Nᵤₖ^{ineq}×Nₛ when the integration portion 185 does not integrate constraint conditions. The number of Lagrange multipliers corresponding to a decreasing number of constraint conditions can be reduced, thus reducing the computational cost of finding a solution to the solution search problem.

Integration for the function that constitutes the unknown inequality constraint condition is expressed as in Expression (38).

$$\begin{matrix}[ Expression 38 ] & \\ {g}_{uk} ( ξ , θ ) = {max}_{j ∈ \{ 1 , … , {N}_{uk}^{ineq} \}} {g}_{j , uk} ( {ξ}_{j} , θ ) ⇋ {{max}^{\sim}}_{j ∈ \{ 1 , … , {N}_{uk}^{ineq} \}} {g}_{j , k} ( {ξ}_{j} , θ ) & ( 38 )\end{matrix}$$

At the time the integration portion 185 performs the calculation of Expression (38), the value of the parameter θ of the constraint condition template is still undetermined. Therefore, the integration portion 185 calculates the function gᵤₖ(ξ, θ) with θ as an argument in the calculation of Expression (38).

Nᵤₖ^{ineq} unknown inequality constraint conditions in the control of the control target 30 are represented in the constraint conditions in the solution search problem by a single function that approximates the maximum value of those functions. As a result, the number of constraint conditions based on unknown inequality constraint conditions, among the constraint conditions in the solution search problem, is Nₛ data series, which is reduced from Nᵤₖ^{ineq}×Nₛ when the integration portion 185 does not perform integration of constraint conditions. The number of Lagrange multipliers corresponding to a decreasing number of constraint conditions can be reduced, thus reducing the computational cost of finding a solution to the solution search problem.

When integrating constraint conditions in the solution search problem for time-series data, the integration portion 185 may integrate the constraint conditions for only some of the plurality of time-series data. For example, when integrating known inequality constraint conditions in the solution search problem for time-series data, the integration portion 185 may integrate the constraint conditions for only some of the plurality of time-series data. When integrating unknown inequality constraint conditions in the solution search problem for time-series data, the integration portion 185 may integrate the constraint conditions for only some of the plurality of time-series data.

When integrating constraint conditions in the solution search problem with respect to the constraint conditions in the control of the control target, the integration portion 185 may integrate only some among the plurality of constraint conditions in the control of the control target. For example, when integrating the known inequality constraint conditions in the solution search problem for the constraint conditions in the control of the control target, the integration portion 185 may integrate only some constraint conditions among the plurality of known inequality constraint conditions in the control of the control target. When integrating unknown inequality constraint conditions in the solution search problem for the constraint conditions in the control of the control target, the integration portion 185 may integrate only sone constraint conditions among the plurality of unknown inequality constraint conditions in the control of the control target.

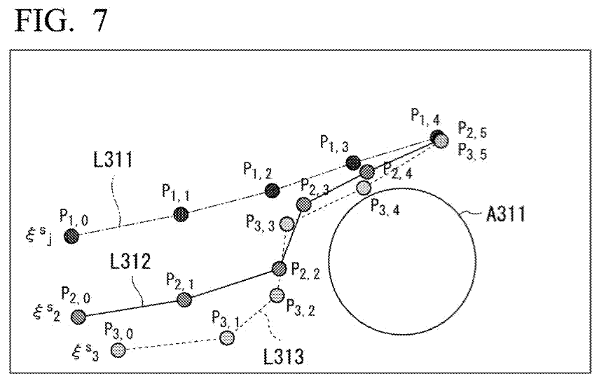

FIG. 7 is a diagram showing an example of data to be integrated by the integration portion 185. In FIG. 7, lines L311, L312, and L313 show the trajectory of the control target 30 during task success, with time-series data for each time period being plotted on each line. Also shown in FIG. 7 is area A311, which shows inequality constraint condition.

As described above, it can be said that the integration portion 185 represents a plurality of data with an approximation of the maximum value, which is the value closest to the boundary of the constraint condition.

For example, in the example in FIG. 7, if the integration portion 185 integrates the success time-series data ξ₁^{s}, ξ₂^{s}, and ξ₃^{s} for the unknown inequality constraint condition indicated in area A311, the integration portion 185, based on Expression (37) above, integrates the success time-series data ξ₃^{s} closest to the area A311.

When the integration portion 185 integrates the data p_{3,0} to p_{3,5} in the success time-series data 838, the integration portion 185 represents the function values obtained by inputting each of these data into the functions of the constraint conditions by the function values obtained by entering the data p_{3, 4} plotted closest to the area A311 into the functions of the constraint conditions.

The constraint condition calculation portion 186 calculates the parameter values of the constraint condition template by solving the solution search problem generated by the problem setting portion 184. This allows the constraint condition estimation portion 182 to estimate unknown inequality constraint conditions.

The constraint condition calculation portion 186 outputs unknown constraint conditions and known constraint conditions to the control device 20.

The control device 20 controls the control target 30 to perform tasks according to the unknown constraint conditions and known constraint conditions.

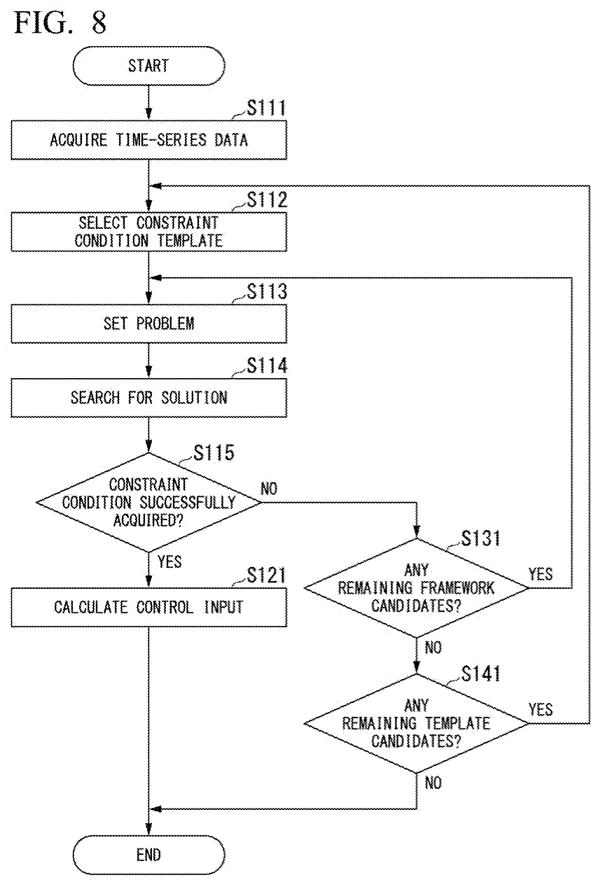

FIG. 8 shows an example of the processing steps performed by control system 1.

In the process shown in FIG. 8, the time-series data acquisition portion 181 acquires Nₛ time-series data ξ₁, . . . ξ_{N} (Step 111). As described above, each of the time-series data is associated with information indicating either task success or task failure.

Next, the template acquisition portion 183 selects, based on the time-series data, a candidate template to be used for setting the constraint conditions in the control of the control target 30, from the templates of unknown inequality constraint conditions stored by the template storage portion 171 (Step S112).

Next, the problem setting portion 184 sets a solution search problem to calculate the parameter values of the constraint condition template (Step S113). The problem setting portion 184 adopts any of the multiple problem frameworks stored by the framework information storage portion 173 to set, for example, a solution search problem based on the number of constraint conditions. The integration portion 185 may also perform integration of data or integration of constraint conditions to simplify the solution search problem.

Next, the constraint condition calculation portion 186 obtains the parameter values of the constraint condition template by searching for solutions to the solution search problem set by the problem setting portion 184 (Step S114).

Subsequently, the constraint condition determination portion 187 determines whether or not the constraint condition calculation portion 186 has successfully calculated the parameter values of the constraint condition template to obtain the constraint condition (Step S115).

If the constraint condition determination portion 187 determines that the constraint condition was successfully acquired (Step S115: YES), the control device 20 calculates the control input to the control target 30 according to the constraint condition and controls the control target 30 to execute the task (Step S121).

After Step S121, the control system 1 terminates the process in FIG. 8.

On the other hand, if the constraint condition determination portion 187 determines in Step S115 that the acquisition of the constraint condition failed (Step S115: NO), the constraint condition determination portion 187 determines whether there are any remaining candidates for a selectable framework among the problem frameworks stored by the framework information storage portion 173 (Step S131).

If the constraint condition determination portion 187 determines that there are still candidates for the framework (Step S131: YES), the process returns to Step S113.

On the other hand, if it is determined in Step S131 that no candidate of the framework remains, the constraint condition determination portion 187 determines whether any selectable candidate of the constraint condition template remains among the constraint condition templates stored by the template storage portion 171 (Step S141).

When the constraint condition determination portion 187 determines that there are still candidates for constraint condition templates (Step S141: YES), the process returns to Step S112.

On the other hand, when the constraint condition determination portion 187 determines in Step S141 that no candidate of the constraint condition template remains (Step S141: NO), the control system 1 terminates the process in FIG. 8. In this case, the control system 1 has failed in the generation of constraint conditions.

As described above, the time-series data acquisition portion 181 acquires success time-series data, which is time-series data pertaining to control over the control target when a predetermined task carried out through the control is successful, and failure time-series data, which is the time-series data in the case of task failure. The template acquisition portion 183 acquires a constraint condition template, which is a constraint condition that includes a parameter. The constraint condition calculation portion 186 determines the value of the parameter such that the constraint condition holds in the success time-series data and the constraint condition does not hold in the failure time-series data.

According to the constraint condition acquisition device 10, constraint conditions other than those set in advance can be acquired.

In addition, the template acquisition portion 183 excludes from acquisition those constraint condition templates for which no parameter values exist, such that the constraint condition holds in the success time-series data and the constraint condition does not hold in the failure time-series data, among the plurality of constraint condition templates.

According to the constraint condition acquisition device 10, it is possible to avoid selecting constraint condition templates that do not conform to the time-series data, and in this respect, constraint conditions can be efficiently acquired.

The problem setting portion 184 sets a solution search problem by determining the assignment method of whether to assign the multiple constraint conditions in the control of the control target to the objective function in the solution search problem or to the constraint conditions in the solution search problem, depending on the type of the constraint condition, and if the value of the parameter is not determined in the solution search problem that has been set, changes the assignment method to reset the solution search problem. The constraint condition calculation portion 186 solves the solution search problem set by the problem setting portion 184 to determine the values of the parameters of the constraint condition template.

According to the constraint condition acquisition device 10, the framework of the solution search problem can be changed to reset the solution search problem when parameter values cannot be obtained, and in this respect, the possibility of obtaining parameter values is high.

For multiple inequality constraint conditions in the solution search problem obtained by inputting each of the multiple time-series data into the same inequality constraint condition in the control of the control target 30, the problem setting portion 184 integrates the multiple inequality constraint conditions in the solution search problem into one inequality constraint condition using the maximum value or minimum value for each of the time-series data and time of the functions that constitute those inequality constraint conditions.

According to the constraint condition acquisition device 10, the number of constraint conditions in a solution search problem can be reduced to simplify the problem. According to the constraint condition acquisition device 10, the computation time is shorter in this respect and the parameter values are more likely to be obtained.

For multiple inequality constraint conditions in the solution search problem, according to the multiple inequality constraint conditions in the control of the control target 30, the problem setting portion 184 integrates multiple functions constituting the inequality constraint condition into a function that approximates the maximum value of each argument value of those multiple function values, or a function that approximates the minimum value of each argument value of those multiple function values, and thereby integrates multiple inequality constraint conditions in the solution search problem into a single inequality constraint condition.

According to the constraint condition acquisition device 10, the number of constraint conditions in a solution search problem can be reduced. According to the constraint condition acquisition device 10, the computation time is shorter in this respect and the parameter values are more likely to be obtained.

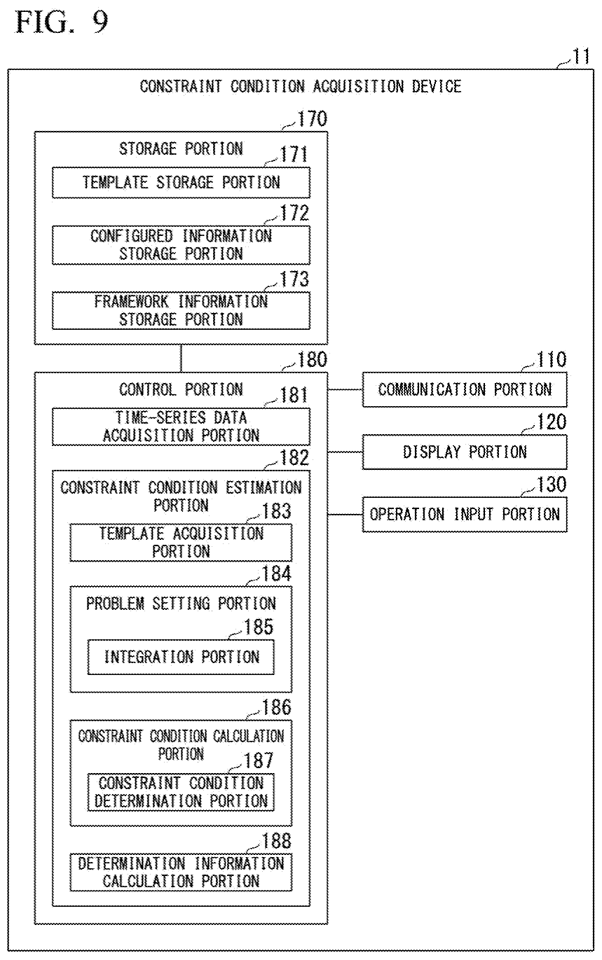

FIG. 9 is a diagram showing an example of the configuration of the constraint condition acquisition device 11 for a modification of the first example embodiment. The constraint condition acquisition device 11 shown in FIG. 9 is used instead of the control system 1, for example, in the configuration of the control system 1 shown in FIG. 1.

In the configuration shown in FIG. 9, the constraint condition acquisition device 11 is provided with the communication portion 110, the display portion 120, the operation input portion 130, the storage portion 170, and the control portion 180. The storage portion 170 is provided with a template storage portion 171, an configured information storage portion 172, and a framework information storage portion 173. The control portion 180 is provided with a time-series data acquisition portion 181 and a constraint condition estimation portion 182. The constraint condition estimation portion 182 is provided with the template acquisition portion 183, the problem setting portion 184, the constraint condition calculation portion 186, and a determination information calculation portion 188. The problem setting portion 184 is provided with the integration portion 185. The constraint condition calculation portion 186 is provided with the constraint condition determination portion 187.

The same reference numerals (110, 120, 130, 170-173, 180-187) are attached to the parts in FIG. 9 that have similar functions corresponding to the parts in FIG. 2, with detailed descriptions being omitted here.

The constraint condition acquisition device 11 differs from the constraint condition acquisition device 10 in that the constraint condition estimation portion 182 is further equipped with the determination information calculation portion 188. In other respects, the constraint condition acquisition device 11 is similar to the constraint condition acquisition device 10.

The determination information calculation portion 188 calculates control command information for the control target 30 in order to execute the task under the value of the parameter whose constraint condition is relaxed compared to the value of the parameter determined by the constraint condition calculation portion 186.

The determination information calculation portion 188 corresponds to an example of the determination information calculation means.

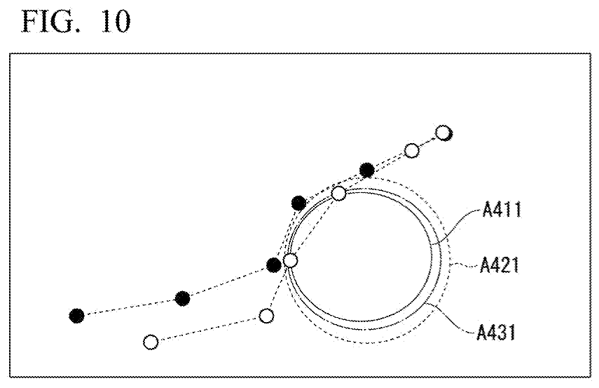

FIG. 10 shows an example of updating a constraint condition.

In the example in FIG. 10, the area A411 shall be an area where a task cannot be accomplished if the control target 30 enters. The area A411 is referred to as the actual restricted access area.

On the other hand, the area A421 shall be an area into which entry of the control target 30 is suppressed by the constraint condition acquisition device 10 setting an unknown constraint condition.

The actual restricted access area A411 is smaller than the restricted access area A421 set by the constraint condition acquisition device 10, and there is room for the control target 30 to move within the restricted access area A421 set by the constraint condition acquisition device 10.

In this case, the determination information calculation portion 188 may set a temporary restricted access area A431 that is smaller than the restricted access area A421 set by the constraint condition acquisition device 10. Then, the determination information calculation portion 188 may instruct the control device 20 to allow the control target 30 to pass through the area of difference between the restricted access area A421 set by the constraint condition acquisition device 10 and the provisional restricted access area. If the task is successful, the constraint condition acquisition device 10 may then re-set the unknown constraint condition so that the path taken by the control target 30 is not included in the restricted access area.

In this case, the control device 20 solves the optimization problem shown in Expression (39), for example, to determine the path of the control target 30.

$$\begin{matrix}[ Expression 39 ] & \\ \{ \begin{matrix}{arg min}_{ξ} & c ( ξ ) , \\ s . t . & {h}_{k} ( ξ ) = 0 , \\ & {g}_{k} ( ξ ) \leq 0 , \\ & {g}_{uk} ( ξ , θ ) < ϵ , \\ & 0 < ϵ\end{matrix} & ( 39 )\end{matrix}$$

In Expression (39), the unknown constraint condition is “gᵤₖ(ξ, θ)<ε”, which means that the constraint is relaxed and the restricted access area is smaller than when “gᵤₖ(ξ, θ)<0”. By solving the optimization problem in Expression (39) to determine the path of the control target 30, the control device 20 can make the control target 30 pass through the area that is considered to be an restricted access area when “gᵤₖ(ξ, θ)<0” and test whether passage is possible or not.

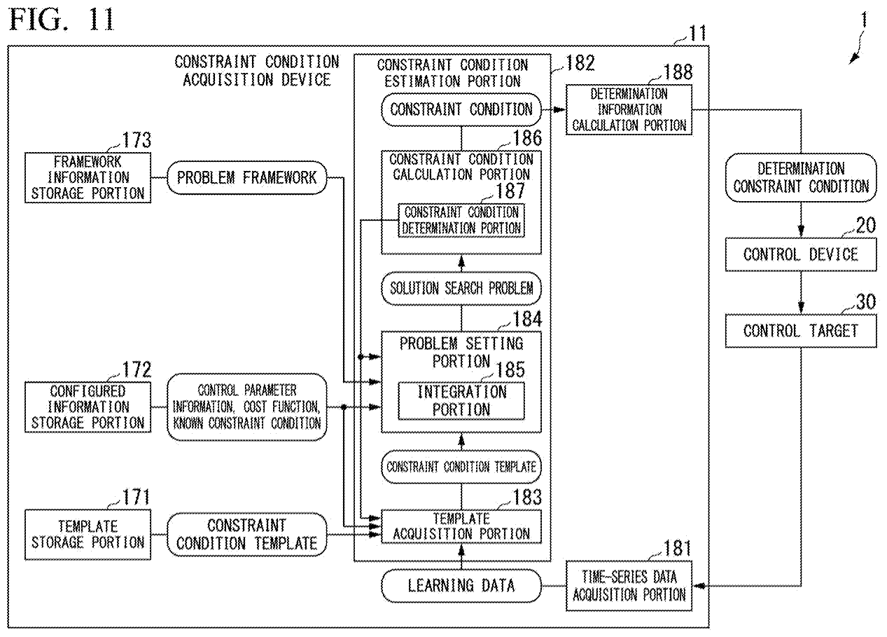

FIG. 11 shows an example of data input/output in a modification of the control system 1. The constraint condition acquisition device 11 in FIG. 11 is provided with the determination information calculation portion 188 in addition to the configuration of the constraint condition acquisition device 10 in FIG. 3. The determination information calculation portion 188 generates a determination constraint conditions based on the set constraint condition and notifies the control device 20. The determination information calculation portion 188 generates constraint conditions as shown in Expression (39), for example, as determination constraint conditions.

By the control device 20 controlling the control target 30 based on the determination constraint conditions, the constraint condition acquisition device 11 can obtain time-series data when the control target 30 performs an action prohibited by the setting of the unknown constraint conditions. The constraint condition acquisition device 11 can determine whether the unknown constraint condition can be relaxed based on the success or failure of the task at this time. Determining whether or not to relax an unknown constraint condition is also referred to as determining the accuracy of the unknown constraint condition or confirming the unknown constraint condition.

In particular, if the set unknown constraint condition does not hold and the time-series data is obtained with a successful task, the constraint condition acquisition device 11 can determine that the unknown constraint condition can be relaxed.

Upon determining that the unknown constraint condition can be relaxed, the constraint condition acquisition device 11 may include the newly obtained time-series data in the training data and recalculate the unknown constraint condition. Recalculating unknown constraint conditions is also referred to as updating unknown constraint conditions.

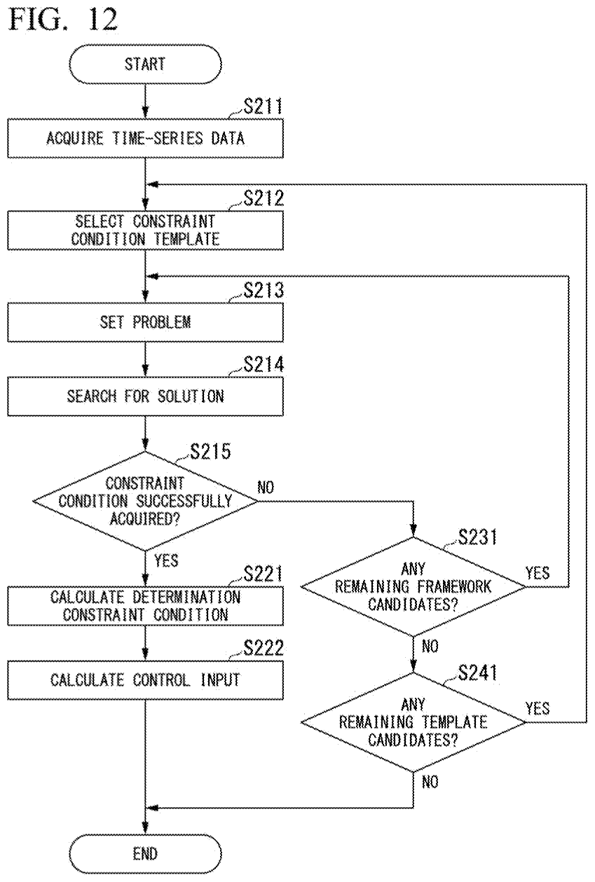

FIG. 12 shows an example of the processing steps in a modification of the control system 1.

Steps S211 through S215 in FIG. 12 are similar to steps S111 through S115 in FIG. 8. Steps S231 and S241 in FIG. 12 are similar to steps S131 and S141 in FIG. 8.

In the process in FIG. 12, if the constraint condition determination portion 187 determines in Step S215 that the constraint condition was successfully acquired (Step S215: YES), the determination information calculation portion 188 calculates the determination constraint condition (Step S221).

The control device 20 executes the task by controlling the control target 30 based on the determination constraint condition (Step S222). This allows the constraint condition acquisition device 11 to acquire time-series data when the control target 30 performs an action that was prohibited by setting of the unknown constraint condition, and to determine the accuracy of the unknown constraint condition.

After Step S222, the control system 1 terminates the process in FIG. 12.

Otherwise, the process in FIG. 12 is similar to the process in FIG. 8.

As described above, the determination information calculation portion 188 calculates control command information for the control target 30 in order to execute tasks under parameter values whose constraint conditions are less restrictive than the parameter values determined by the constraint condition calculation portion 186.

This allows the constraint condition acquisition device 11 to acquire time-series data when the control target 30 performs an action that was prohibited by the setting of an unknown constraint condition. Based on this time-series data and task success or failure, the constraint condition acquisition device 11 can determine the accuracy of the unknown constraint condition and can update the unknown constraint condition as necessary.

The constraint condition acquisition device 11 may use the temporal logic expression in addition to the constraint condition equation to set constraint conditions in the control of the control target 30.

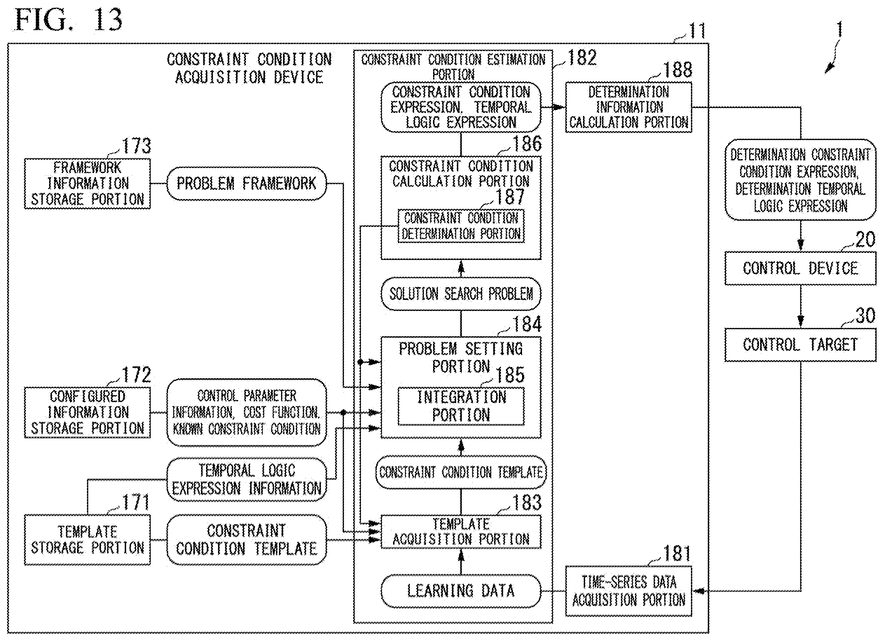

FIG. 13 shows an example of data input/output when the constraint condition acquisition device 11 uses a temporal logic expression in addition to the constraint condition equation.

In the example in FIG. 13, the template storage portion 171 stores temporal logic expression information in addition to the constraint condition templates. Temporal logic expression information is information relating to the learning of temporal logic, such as the type and number of temporal logics. The template storage portion 171 may store temporal logic expression information including templates of temporal logic expressions.

In addition to the information to be obtained in the case of FIG. 11, the problem setting portion 184 acquires temporal logic expression information from the template storage portion 171. The problem setting portion 184 learns the temporal logic to generate some of the constraint conditions in the control of the control target 30 with temporal logic expressions. Known methods can be used by the problem setting portion 184 to learn the temporal logic.

The problem setting portion 184 generates a solution search problem in which some of the constraint conditions are indicated by temporal logic. For example, the problem setting portion 184 may indicate constraint conditions that change over time with temporal logic expressions and indicate constraint conditions that do not change over time with constraint condition expressions.

The constraint condition calculation portion 186 solves the solution search problem set by the problem setting portion 184. If the constraint condition determination portion 187 determines that the parameter values of the constraint condition template have been acquired, the constraint condition calculation portion 186 sets the parameter values in the constraint condition template to generate unknown constraint conditions. The constraint condition calculation portion 186 then outputs the unknown constraint conditions and unknown constraint conditions to the determination information calculation portion 188. Some of the constraint conditions may be indicated by temporal logic expressions.

For the determination constraint conditions sent by the determination information calculation portion 188 to the control device 20, some of the constraint conditions may also be indicated by temporal logic expressions.

Other than the above, FIG. 13 is similar to FIG. 11.

The temporal logic used by the constraint condition acquisition device 11 can be various types such as Linear Temporal Logic (LTL), Metric Interval Temporal Logic (MITL), Signal Temporal Logic (STL), Parametric Signal Temporal Logic (PSTL), or Computational Tree Logic (CTL).

The following is an example of a case in which the constraint condition acquisition device 11 uses STL.

The constraint condition acquisition device 11 sets constraint conditions by temporal logic using, for example, “and” (φ₁∧φ₂), “or” (φ₁∨φ₂), “finally” (F_{[a, b]}φ) “global” (G_{[a, b]}φ), or a combination of these templates.

“F_{[a, b]}φ” denotes the proposition that the proposition φ is true at least once between times a and b. “G_{[a, b]}φ” denotes the proposition that the proposition φ is true throughout the period from time a to b.

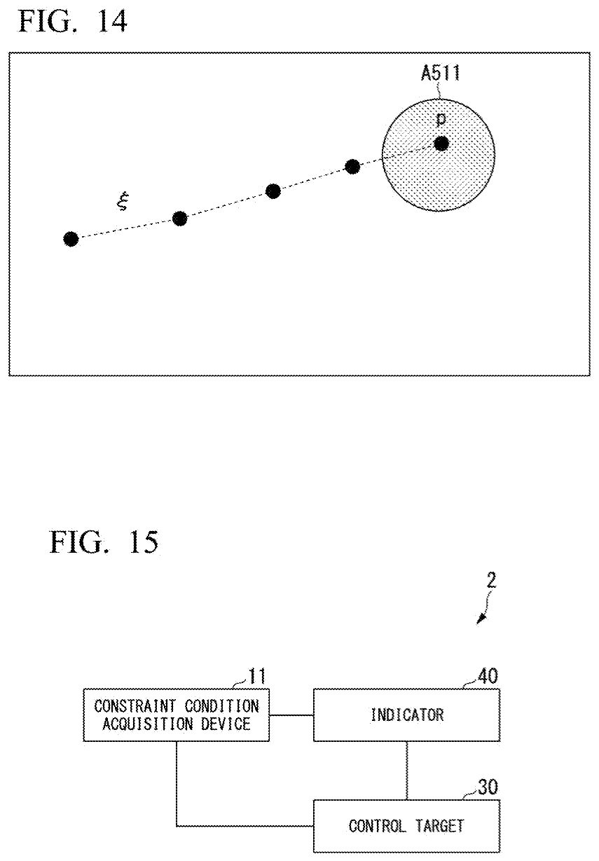

FIG. 14 shows an example of the area indicated by a constraint condition expressed using temporal logic.

In the example in FIG. 14, the area A511 shall be represented by the unknown inequality constraint condition of Expression (40), and the inequality constraint condition holds if the control target 30 is located within the area A511.

$$\begin{matrix}[ Expression 40 ] & \\ {g}_{g , u k} ( p , {θ}_{g} ) \leq 0 & ( 40 )\end{matrix}$$

p represents the position of the control target 30. θ_{g} is a parameter for setting the area, such as the position and size of the area of the constraint condition.

Consider the case where the problem setting portion 184 sets the constraint condition that “the control target 30 is located within the area A511 at least once between time a and b”.

Using g_{g, uk} in Expression (40), the function ρ^{φ}(ξ, tₖ), which is the robustness degree function for the proposition that the control target 30 is located within the area A511, can be expressed as in Expression (41).

$$\begin{matrix}[ Expression 41 ] & \\ {ρ}^{ϕ} ( ξ , {t}_{k} ) = - {g}_{g , uk} ( {p}_{{t}_{k}} , {θ}_{g} ) + ϵ & ( 41 )\end{matrix}$$

tₖ represents time, and pₜₖ represents the position of the control target 30 at time tₖ. ε represents a positive minute constant.

The robustness degree function is a function that approximately indicates whether a proposition in signal temporal logic holds or not based on the positive or negative value of the function. The function ρ^{φ}(ξ, tₖ) outputs a positive function value when the control target 30 is located within the area 411.

ε represents the margin between the location of the control target 30 and the area 411 when the control target 30 is located outside of the area 511. If the value of the function ρ^{φ}(ξ, tₖ) is negative, the control target 30 is located more than an interval equal to ε away from the area 511.

The function ρ^{F[a, b]φ}(ξ, tₖ), which is the robustness degree function for the proposition that “at least once between times a and b, the control target 30 is located within the area A511,” can be approximated as in Expression (42).

$$\begin{matrix}[ Expression 42 ] & \\ {ρ}^{{F}_{[ a , b ]} ϕ} ( ξ , {t}_{k} ) ⇋ {{max}^{\sim}}_{{t}^{′} ∈ [ {t}_{k} + a , {t}_{k} + b ]} {ρ}^{ϕ} ( ξ , {t}^{′} ) & ( 42 )\end{matrix}$$

tₖ indicates the reference time, and times a and b are indicated by the time when time tₖ is set to time 0, respectively.

The fact that “ρ^{F[a, b]φ}(ξ, tₖ)≥0” holds indicates approximately that the proposition that “at least once between times a and b the control target 30 is located within the area A511.”

The proposition that “at least once between times a and b, the control target 30 is located within the area A511” is approximated by the unknown inequality constraint condition shown in Expression (43).

$$\begin{matrix}[ Expression 43 ] & \\ {g}_{{F}_{[ a , b ]} g , uk} ( ξ , [ {θ}_{g} ; a ; b ] ) \leq 0 & ( 43 )\end{matrix}$$

Expression (43) can be constructed as a constraint condition template with θ_{g}, a and b as parameters. By setting the values of the parameters θ_{g}, a, and b, the constraint calculation portion 186 acquires the unknown inequality constraint condition.

Thus, for a proposition expressed in terms of a logic expression in signal temporal logic, by approximating the robustness degree function of the proposition with a maximum value approximation function, it is possible to express the proposition in signal temporal logic in the form of an inequality constraint condition.

The constraint condition templates stored by the template storage portion 171 may include constraint condition templates that represent propositions in signal temporal logic in the form of inequality constraint conditions. Then, the constraint condition template selected by the template acquisition portion 183 may include a constraint condition template that expresses a proposition in signal temporal logic in the form of an inequality constraint condition. By solving the solution search problem, the constraint condition calculation portion 186 also finds parameter values for constraint condition templates that represent propositions in signal temporal logic in the form of inequality constraint conditions, whereby unknown inequality constraint conditions are set.

As described above, the problem setting portion 184 generates a solution search problem in which some of the constraint conditions are indicated by temporal logic expressions.

This allows the constraint conditions in the control of the control target 30 to be shown in greater detail, and the control device 20 can control the control target 30 with greater precision.

### Second Example Embodiment

FIG. 15 shows an example of the configuration of a control system 2 according to the second example embodiment.

In the configuration shown in FIG. 15, the control system 2 is provided with a constraint condition acquisition device 11, an indicator 40, and a control target 30. The constraint condition acquisition device 11 is the same as described in FIGS. 9 through 13, and so a detailed description is omitted here. The control target 30 is the same as described with reference to FIG. 1 and the like, and so a detailed description is omitted here.

The control system 2 receives user operations to the control target 30 in order to check for unknown constraint conditions. In all other respects, the control system 2 is similar to the control system 1.

The indicator 40 controls the control target 30 as well as the control device 20. In addition, the indicator 40 receives user operations on the control target 30 and controls the control target 30 according to the user operations.

The indicator 40 is composed of a computer, such as a personal computer. Alternatively, the indicator 40 may be configured using hardware dedicated to the indicator 40, such as configured using an ASIC or FPGA.

The constraint condition acquisition device 10 and the indicator 40 may be integrally configured. For example, the constraint condition acquisition device 10 and the indicator 40 may run on the same computer.

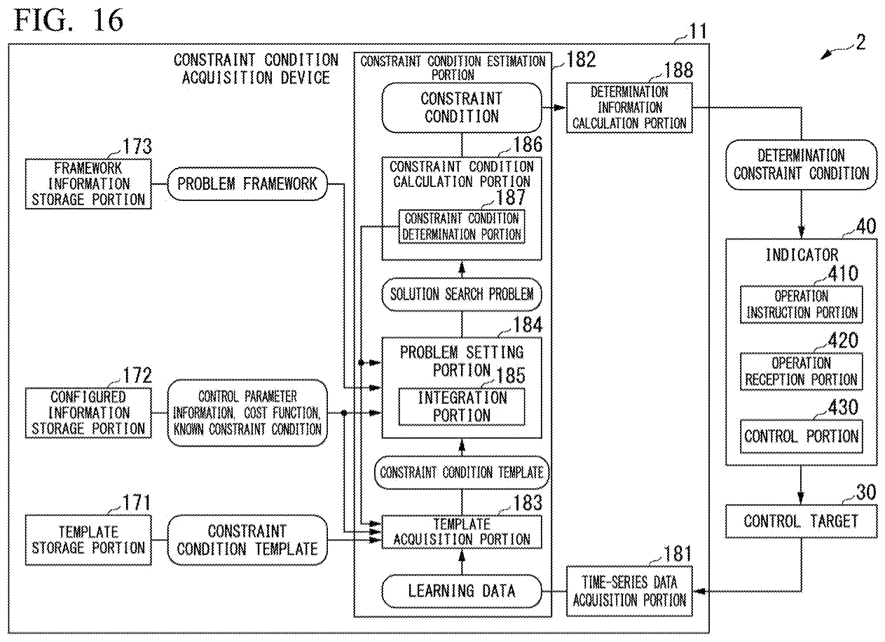

FIG. 16 shows an example of data input/output in the control system 2. Comparing FIG. 16 with FIG. 11, in FIG. 16, the indicator 40 is provided in place of the control device 20. The indicator 40 is provided with an operation instruction portion 410, an operation reception portion 420, and a control portion 430.

In other respects, the control system 2 shown in FIG. 16 is similar to the control system 1 shown in FIG. 11.

The operation instruction portion 410 instructs the user to perform a user operation in order to check unknown constraint conditions. In particular, the operation instruction portion 410 instructs user operations on the control target 30 to execute tasks under more relaxed constraint conditions than those set as unknown constraint conditions.

For example, if an upper limit for the movement speed of the control target 30 is set as an unknown constraint condition, the operation instruction portion 410 may display a message instructing the user to move the control target 30 faster.

In this case, the operation instruction portion 410 may indicate a specific upper speed limit that is set as an unknown constraint condition and prompt the user to perform movement faster than that, but it is possible that the user may not be able to intuitively ascertain the upper speed limit that is presented. This may result in the user not knowing how fast to move the control target 30, and thus may not be able to operate the control target 30 well.

Therefore, the operation instruction portion 410 may display a message conveying the desire for the robot arm to move a bit faster, such as “Please move the robot arm a little faster” without providing a specific speed. If the user operation does not produce a speed equal to or greater than the upper speed limit set as an unknown constraint condition, the operation instruction portion 410 may display a message prompting the user to perform the operation to make the control target 30 move faster, such as “Please move the robot arm even faster”.

In this case, the message “Please move the robot arm even faster” is an example of information indicating an operation that causes the control target 30 to perform a different action than that indicated in the operation performed by the user. The operation instruction portion 410 corresponds to an example of an operation instruction means.

The operation reception portion 420 receives user operations. In particular, the operation reception portion 420 receives user operations that manipulate the control target 30. For example, the operation reception portion 420 may be provided with a joystick or other operating device to receive user operations indicating the direction and speed of movement of the control target 30.

A user operation here corresponds to an example of an operation that operates the control target 30. The operation reception portion 420 correspond to an example of an operation reception means.

The control portion 430 controls the control target 30 in the same way as the control device 20. When the operation reception portion 420 receives a user operation on the control target 30, the control portion 430 controls the control target 30 according to the user operation.

The control portion 430 also determines whether it is necessary to make the control target 30 perform an action different from the action indicated in the operation performed by the user. In the above example, the control portion 430 determines whether it is necessary to make the control target 30 operate even faster by determining whether the speed resulting from user operation is equal to or greater than the upper speed limit, which is set as an unknown constraint condition.

The control portion 430 corresponds to an example of a determination means.

The items that the operation instruction portion 410 indicates with respect to user operation are not limited to the speed of the control target 30 described above, but can be a variety of items.

For example, if the parameter of the constraint condition template being checked is a parameter for setting an obstacle area (an area that prohibits the entry of the control target 30), the operation instruction portion 410 may display a message such as “Please operate the robot arm so that it passes close to the obstacle”.

If the control portion 430 determines that the user operation has caused the control target 30 to enter inside the area of the obstacle set as an unknown constraint condition, the operation instruction portion 410 may display a message such as “Please operate the robot arm to pass even closer to the obstacle”.

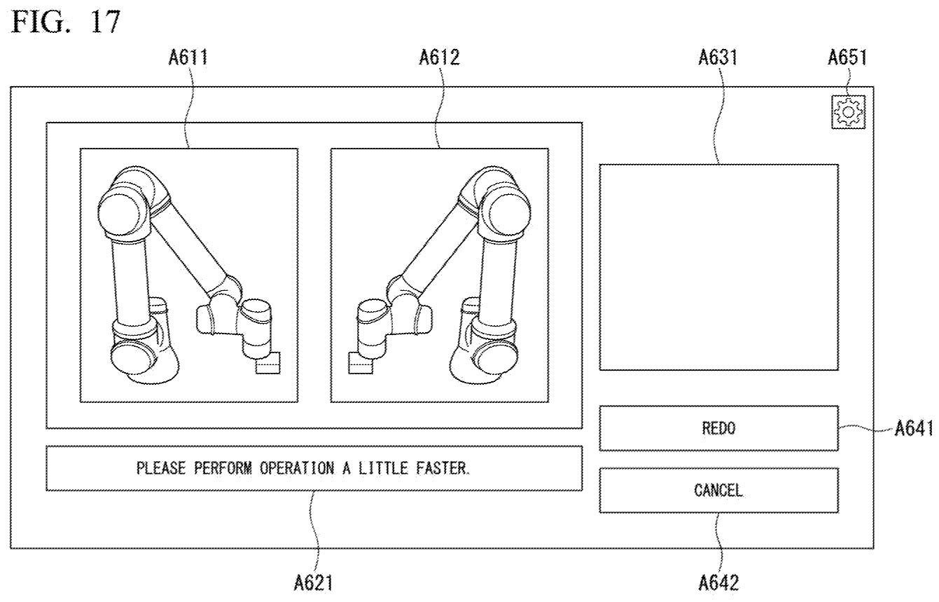

FIG. 17 shows an example of a screen display by the operation instruction portion 410.

The area A611 is an area that displays an image of the current state of the control target 30. The area A612 is an area where the state of the target of the control target 30 is displayed in an image. By displaying the current state and target state of the control target 30 in the image, the user can visualize the change from the current state of the control target 30 to the target state, which is expected to facilitate operations on the control target 30.

Area A621 is an area for displaying messages to the user about the operation of the control target 30. As described above, the operation instruction portion 410 does not present specific speeds or other concrete quantities, but may present points for the user to keep in mind during operation, such as “Please move the robot arm a little faster”. If time-series data to determine the accuracy of unknown constraint conditions cannot be acquired, the operation instruction portion 410 may prompt the user to perform another operation by presenting points for the user to be aware of during the operation, such as “Please move the robot arm even faster”.

Area A631 is a display area for various information. For example, in the area A631 there may be displayed status information on whether the control target 30 is normal or abnormal, setting items in unknown constraint conditions being checked by the determination information calculation portion, the current confirmation status of the setting items being checked, the number of time-series data required for checking, the constraint conditions set in the control of the control target 30, and the like.

Area A641 is the operation area when the user wants to redo an operation. When the operation instruction portion 410 receives a user operation such as a touch operation or mouse click on the area A641, the control portion 430 may return the state of the control target 30 to its initial state, and the operation reception portion 420 may receive a user operation from the initial state of the control target 30.

Area A642 is the operation area when the user wants to cancel the process. When the operation instruction portion 410 receives a user operation such as a touch operation or mouse click on the area A642, it aborts the instruction to the user to operate the control target 30. In this case, the control system 2 may transition to a mode of automatically checking unknown constraint conditions, as in the case of the first modification. Alternatively, the control system 2 may finish the checking of unknown constraint conditions.

Area A651 is the operation area for transitioning to the display settings screen. When the operation instruction portion 410 receives a user operation such as a touch operation or mouse click on the area A651, it switches the display screen to the display settings screen. The display settings screen is a screen for receiving various settings related to the display by the operating instruction portion 410.

As described above, the operation reception portion 420 acquires operations to operate the control target 30. The control portion 430 determines whether it is necessary to make the control target 30 perform an action different from that indicated in the operation performed by the user.

If the control portion 430 determines that it is necessary to have the control target perform the different operation, the operation instruction portion 410 displays information indicating the operation that causes the control target to perform the different operation.

By the user operating the control target 30 according to the instructions, the constraint condition acquisition device 11 can acquire time-series data when the constraint condition is relaxed, as well as result information on whether the task succeeded or failed. This allows the constraint condition acquisition device 11 to determine whether the unknown constraint condition can be relaxed, and to re-set the unknown constraint conditions as necessary.

When it is not possible to determine whether a constraint condition can be relaxed in the time-series data obtained from the user operation, by means of the operation instruction portion 410 presenting an item to be changed from the previous user operation to instruct another user operation, the constraint condition acquisition device 11 can more reliably determine whether the unknown constraint condition can be relaxed and, if necessary, reset the unknown constraint condition.

In addition, it is expected that when the user performs operations for task execution while visually checking the status of the control target 30, the likelihood of task success is relatively high and it is easy to obtain useful time-series data for checking unknown constraint conditions.

### Third Example Embodiment

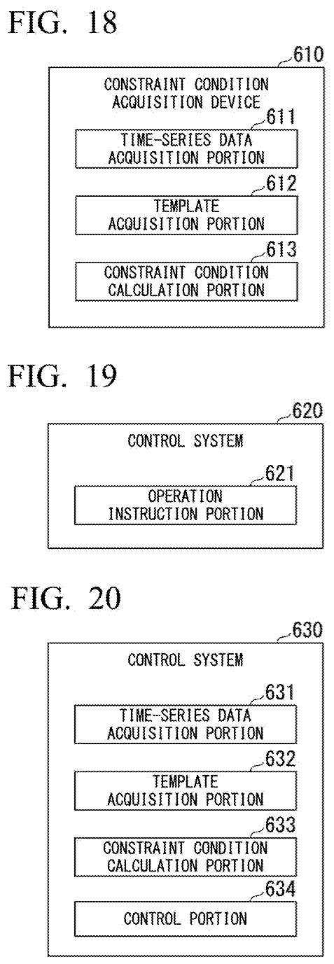

FIG. 18 is a diagram showing an example of the configuration of the constraint condition acquisition device according to the third example embodiment.

In the configuration shown in FIG. 18, a constraint condition acquisition device 610 is provided with a time-series data acquisition portion 611, a template acquisition portion 612, and a constraint condition calculation portion 613. In such a configuration, the time-series data acquisition portion 611 acquires success time-series data, which is time-series data pertaining to control over a control target when a predetermined task carried out through the control is successful, and failure time time-series data, which is the time-series data in the case of task failure. The template acquisition portion 612 acquires a constraint condition template, which is a constraint condition that includes a parameter. The constraint condition calculation portion 613 determines the value of the parameter such that the constraint condition holds in the success time-series data and the constraint condition does not hold in the failure time-series data.

The time-series data acquisition portion 611 corresponds to an example of a time-series data acquisition means. The template acquisition portion 612 corresponds to an example of a template acquisition means. The constraint condition calculation portion 613 corresponds to an example of a constraint condition calculation means.

According to the constraint condition acquisition device 610, constraint conditions other than those set in advance can be acquired.

The time-series data acquisition portion 611 can be realized, for example, using functions such as the time-series data acquisition portion 181 in FIG. 2. The template acquisition portion 612 can be realized, for example, using functions such as the template acquisition portion 183 in FIG. 2. The functions of the constraint condition calculation portion 613 can be realized, for example, using the functions of the constraint condition calculation portion 186 in FIG. 2.

### Fourth Example Embodiment

FIG. 19 is a diagram showing an example of the configuration of the control system according to the fourth example embodiment. In the configuration shown in FIG. 19, a control system 620 is provided with an operation instruction portion 621.

In such a configuration, the operation instruction portion 621, during execution of a predetermined task performed through control over a control target, instructs a user operation on the control target to execute the task under a more relaxed constraint condition than the constraint condition set for the control.

The operation instruction portion 621 corresponds to an example of an operation instruction means.

In the control system 620, by the user operating the control target according to the instructions, time-series data when the constraint condition is relaxed, as well as result information on whether the task succeeded or failed are obtained. This allows the accuracy of the set constraint condition to be judged, and the constraint condition can be re-set if necessary.

The functions of the operation instruction portion 621 can be realized, for example, using the functions of the operation instruction portion 410 in FIG. 16.

### Fifth Example Embodiment

FIG. 20 is a diagram showing an example of the configuration of the control system according to the fifth example embodiment. In the configuration shown in FIG. 20, a control system 630 is provided with a time-series data acquisition portion 631, a template acquisition portion 632, a constraint condition calculation portion 633, and a control portion 634.

In such a configuration, the time-series data acquisition portion 631 acquires success time-series data, which is time-series data pertaining to control over a control target when a predetermined task carried out through the control is successful, and failure time time-series data, which is the time-series data in the case of task failure. The template acquisition portion 632 acquires a constraint condition template, which is a constraint condition including a parameter. The constraint condition calculation portion 633 determines the values of the parameter such that the constraint condition holds in the success time-series data and the constraint condition does not hold in the failure time-series data. The control portion 634 performs a predetermined task by controlling the control target according to the constraint condition indicated by setting the value of the parameter determined in the constraint condition template.

The time-series data acquisition portion 631 corresponds to an example of a time-series data acquisition means. The template acquisition portion 632 corresponds to an example of a template acquisition means. The constraint condition calculation portion 633 corresponds to an example of a constraint condition calculation means. The control portion 634 corresponds to an example of a control means.

According to the control system 630, a constraint condition other than a constraint condition set in advance can be acquired.

The time-series data acquisition portion 631 can be realized, for example, using functions such as the time-series data acquisition portion 181 in FIG. 2. The template acquisition portion 632 can be realized, for example, using functions such as the template acquisition portion 183 in FIG. 2. The constraint condition calculation portion 633 can be realized, for example, using the functions of the constraint condition calculation portion 186 in FIG. 2. The control portion 634 can be realized using the functions of, for example, the control device 20 of FIG. 1.

### Sixth Example Embodiment

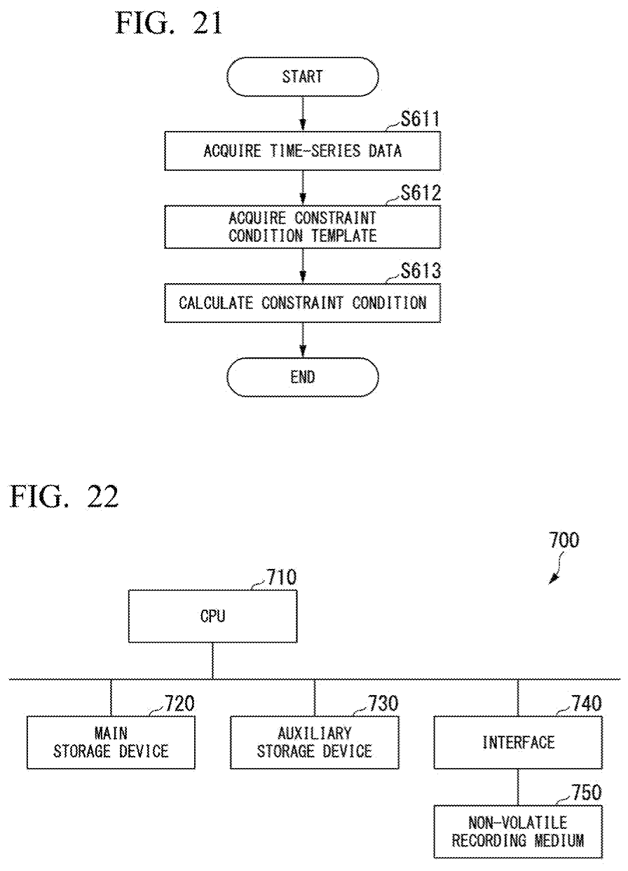

FIG. 21 is a diagram showing an example of the processing steps in the constraint condition acquisition method according to the sixth example embodiment. The constraint condition acquisition method shown in FIG. 21 includes acquiring time-series data (Step S611), acquiring a constraint condition template (Step S612), and calculating the constraint condition (Step S613).

In acquiring time-series data (Step S611), the computer acquires success time-series data, which is time-series data pertaining to control over a control target when a predetermined task carried out through the control is successful, and failure time-series data, which is the time-series data in the case of task failure.

In acquiring a constraint condition template (Step S612), the computer acquires a constraint condition template, which is a constraint condition that includes a parameter.

In calculating the constraint condition (Step S613), the computer determines the values of the parameter such that the constraint condition holds in the success time-series data and the constraint condition does not hold in the failure time-series data.

According to the process shown in FIG. 21, a constraint condition other than a constraint condition set in advance can be acquired.

FIG. 22 is an outline block diagram showing the configuration of a computer according to at least one example embodiment.

In the configuration shown in FIG. 22, a computer 700 is provided with a CPU 710, a main storage device 720, an auxiliary storage device 730, an interface 740, and a nonvolatile recording medium 750.

Any one or more of the above constraint condition acquisition device 10, constraint condition acquisition device 11, control device 20, and indicator 40, or any part thereof, may be implemented in the computer 700. In that case, the operations of each of the above-mentioned processing portions are stored in the auxiliary storage device 730 in the form of a program. The CPU 710 reads the program from the auxiliary storage device 730, deploys it in the main storage device 720, and executes the above processing according to the program. The CPU 710 also reserves a storage area in the main storage device 720 corresponding to each of the above-mentioned storage portions according to the program. Communication between each device and other devices is performed by the interface 740, which has a communication function and communicates according to the control of the CPU 710. The interface 740 also has a port for nonvolatile recording medium 750 and reads information from and writes information to the nonvolatile recording medium 750.

When the constraint condition acquisition device 10 is implemented in the computer 700, the operations of the control portion 180 and the various parts thereof are stored in the auxiliary storage device 730 in the form of a program. The CPU 710 reads the program from the auxiliary storage device 730, deploys it in the main storage device 720, and executes the above processing according to the program.

The CPU 710 also reserves a storage area in the main storage device 720 corresponding to the storage portion 170 and the various parts thereof according to the program. The communication performed by the communication portion 110 is executed by the interface 740, which has a communication function and communicates according to the control of the CPU 710. The display of images by the display portion 120 is performed by the interface 740, which is equipped with a display device and displays images according to the control of the CPU 710. Reception of a user operation by the operation input portion 130 is performed by the interface 740 being equipped with an input device to receive user operations.

When the constraint condition acquisition device 11 is implemented in the computer 700, the operations of the control portion 180 and the various parts thereof are stored in the auxiliary storage device 730 in the form of a program. The CPU 710 reads the program from the auxiliary storage device 730, deploys it in the main storage device 720, and executes the above processing according to the program.

The CPU 710 also reserves a storage area in the main storage device 720 corresponding to the storage portion 170 and the various parts thereof according to the program. The communication performed by the communication portion 110 is executed by the interface 740, which has a communication function and communicates according to the control of the CPU 710. The display of images by the display portion 120 is performed by the interface 740, which is equipped with a display device and displays images according to the control of the CPU 710. Reception of a user operation by the operation input portion 130 is performed by the interface 740 being equipped with an input device to receive user operations.

When the control device 20 is implemented in the computer 700, the operation of the control device 20 is stored in the auxiliary storage device 730 in the form of a program. The CPU 710 reads the program from the auxiliary storage device 730, deploys it in the main storage device 720, and executes the above processing according to the program.

The CPU 710 also, according to the program, reserves a storage area in the main storage device 720 for processing by the control device 20.

Communication between the control device 20 and other devices is performed by the interface 740, which has a communication function and operates according to the control of the CPU 710.

Interaction between the control device 20 and the user is performed by the interface 740 having input and output devices, presenting information to the user with the output devices and receiving user operations with the input devices according to the control of the CPU 710.

When the indicator 40 is implemented in the computer 700, operations of the indicator 40, including the operation of the control portion 430, are stored in the auxiliary storage device 730 in the form of a program. The CPU 710 reads the program from the auxiliary storage device 730, deploys it in the main storage device 720, and executes the above processing according to the program.

The CPU 710 also, according to the program, reserves a storage area in the main storage device 720 for processing by the indicator 40.

Communication between the indicator 40 and other devices is performed by the interface 740, which has a communication function and operates according to the control of the CPU 710.

The output of instructions by the operation instruction portion 410 is performed by the interface 740 having an output device and outputting instructions by the output device according to the control of the CPU 710. The reception of user operations by the operation reception portion 420 is performed by the interface 740 having an input device to receive user operations.

Any one or more of the above programs may be recorded on the nonvolatile recording medium 750. In this case, the interface 740 may read the program from the nonvolatile recording medium 750. The CPU 710 may then directly execute the program read by the interface 740, or may once store it in the main storage device 720 or the auxiliary storage device 730 for subsequent execution.

A program for executing all or some of the processes performed by the constraint condition acquisition device 10, constraint condition acquisition device 11, control device 20, and indicator 40 may be recorded on a computer-readable recording medium, and by having the computer system read and execute the program recorded on this recording medium, the processing of each part may be performed by the computer system. The term “computer system” here shall include an operating system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

The above example embodiments of this invention have been described in detail with reference to the drawings. Specific configurations are not limited to these example embodiments, but also include designs, etc., to the extent that they do not depart from the gist of this invention.

### INDUSTRIAL APPLICABILITY

The present invention may be applied to a constraint condition acquisition device, a control system, a constraint condition acquisition method, and a recording medium.

### DESCRIPTION OF REFERENCE SIGNS

1, 2 Control system
10, 11 Constraint condition acquisition device
20 Control device
30 Control target
40 Indicator
110 Communication portion
120 Display portion
130 Operation input portion
170 Storage portion
171 Template storage portion
172 Configured information storage portion
173 Framework information storage portion
180 Control portion
181 Time-series data acquisition portion
182 Constraint condition estimation portion
183 Template acquisition portion
184 Problem setting portion
185 Integration portion
186 Constraint condition calculation portion
187 Constraint condition determination portion
188 Determination information calculation portion
410 Operation instruction portion
420 Operation reception portion
430 Control portion

What is claimed is:

1. A constraint condition acquisition device comprising:
at least one memory configured to store instructions; and
at least one processor configured to execute the instructions to:
acquire success time time-series data, which is time-series data pertaining to control over a control target when a predetermined task carried out through the control is successful, and failure time time-series data, which is the time-series data in the case of task failure;
acquire a constraint condition template, which is a constraint condition that includes a parameter; and
determine the value of the parameter such that the constraint condition holds in the success time-series data and the constraint condition does not hold in the failure time-series data.

2. The constraint condition acquisition device according to claim 1, wherein the at least one processor is configured to execute the instructions to exclude from the acquisition target the constraint condition template for which the value of the parameter does not exist such that the constraint condition holds in the success time-series data and the constraint condition does not hold in the failure time-series data, among a plurality of the constraint condition templates.

3. The constraint condition acquisition device according to claim 1, wherein the at least one processor is configured to execute the instructions to:
set a solution search problem by determining an assignment method of whether to assign multiple constraint conditions in the control of the control target to an objective function in the solution search problem, or to the constraint condition in the solution search problem, depending on the type of the constraint condition, and if the value of the parameter is not determined by the solution search problem that has been set, changes the assignment method to reset the solution search problem; and
determine the value of the parameter by solving the set solution search problem.

4. The constraint condition acquisition device according to claim 3, wherein for multiple inequality constraint conditions in the solution search problem obtained by inputting each of the multiple time-series data into the same inequality constraint condition in the control of the control target, the problem setting means integrates the multiple inequality constraint conditions in the solution search problem into one inequality constraint condition using the maximum value or minimum value for each of the time-series data and time of the functions that constitute those inequality constraint conditions.

5. The constraint condition acquisition device according to claim 3, wherein for multiple inequality constraint conditions in the solution search problem, according to the multiple inequality constraint conditions in the control of the control target, the problem setting means integrates multiple functions constituting the inequality constraint condition into a function that approximates the maximum value of each argument value of those multiple function values, or a function that approximates the minimum value of each argument value of those multiple function values, and thereby integrates multiple inequality constraint conditions in the solution search problem into a single inequality constraint condition.

6. The constraint condition acquisition device according to, claim 1, wherein the at least one processor is configured to execute the instructions to calculate control command information for the control target in order to execute the task under the value of the parameter whose constraint condition is relaxed compared to the determined value of the parameter.

7. A control system comprising:
at least one memory configured to store instructions; and
at least one processor configured to execute the instructions to:
acquire an operation to operate the control target;
determine whether or not it is necessary to cause the control target to perform an operation different from the operation indicated in the operation; and
display, when it is determined that it is necessary to cause the control target to perform the different operation, information indicating an operation to cause the control target to perform the different operation.

8. (canceled)

9. A constraint condition acquisition method executed in a computer, the method comprising:
acquiring success time time-series data, which is time-series data pertaining to control over a control target when a predetermined task carried out through the control is successful, and failure time time-series data, which is the time-series data in the case of task failure;
acquiring a constraint condition template, which is a constraint condition that includes a parameter; and
determining the value of the parameter such that the constraint condition holds in the success time-series data and the constraint condition does not hold in the failure time-series data.

10. (canceled)

11. The constraint condition acquisition device according to claim 2, wherein the at least one processor is configured to execute the instructions to:
set a solution search problem by determining an assignment method of whether to assign multiple constraint conditions in the control of the control target to an objective function in the solution search problem, or to the constraint condition in the solution search problem, depending on the type of the constraint condition, and if the value of the parameter is not determined by the solution search problem that has been set, changes the assignment method to reset the solution search problem; and
determine the value of the parameter by solving the set solution search problem.

12. The constraint condition acquisition device according to claim 4, wherein for multiple inequality constraint conditions in the solution search problem, according to the multiple inequality constraint conditions in the control of the control target, the problem setting means integrates multiple functions constituting the inequality constraint condition into a function that approximates the maximum value of each argument value of those multiple function values, or a function that approximates the minimum value of each argument value of those multiple function values, and thereby integrates multiple inequality constraint conditions in the solution search problem into a single inequality constraint condition.

13. The constraint condition acquisition device according to claim 2, wherein the at least one processor is configured to execute the instructions to calculate control command information for the control target in order to execute the task under the value of the parameter whose constraint condition is relaxed compared to the determined value of the parameter.

14. The constraint condition acquisition device according to claim 3, wherein the at least one processor is configured to execute the instructions to calculate control command information for the control target in order to execute the task under the value of the parameter whose constraint condition is relaxed compared to the determined value of the parameter.

15. The constraint condition acquisition device according to claim 4, wherein the at least one processor is configured to execute the instructions to calculate control command information for the control target in order to execute the task under the value of the parameter whose constraint condition is relaxed compared to the determined value of the parameter.

16. The constraint condition acquisition device according to claim 5, wherein the at least one processor is configured to execute the instructions to calculate control command information for the control target in order to execute the task under the value of the parameter whose constraint condition is relaxed compared to the determined value of the parameter.
